(19) United States
(12) Patent Application Publication
(10) Pub. No.: US 2002/0026401 A1
(43) Pub. Date: Feb. 28, 2002

(54) System and method for facilitating electronic bidding between buyers and sellers in financial industries

(76) Inventor: Kelli Hustad Hueler, Eden Prarie, MN (US)

Correspondence Address: Steven R. Funk, Altera Law Group, LLC, Suite 100, 6500 City West Parkway, Minneapolis, MN, 55344-7701, US

(21) Appl. No.: 09/790,268

(22) Filed: Feb. 21, 2001

Related U.S. Application Data
(60) Provisional application No. 60/184,166, filed on Feb. 21, 2000.

(51) Int. Cl. G06F 17/60

(52) U.S. Cl. 705/37; 705/36

(57) ABSTRACT

A system and method for facilitating electronic bidding between stable value fund managers and stable value contract issuers. A fund manager creates an electronic bid invitation, and identifies the contract issuers from whom a responsive bid is desired. The electronic bid invitation is electronically dispatched to the designated issuers in order to prompt the issuers to furnish the bid. Electronic bid responses are submitted by the designated issuers back to the manager in response to the electronic bid invitations. The manager identifies the best bid response from all of the bid responses received. The issuer who submitted the most favorable bid response is notified through an electronic transmission that the manager would like to enter into an investment contract with that issuer, at terms substantially defined in the seller's winning bid response.

### RELATED APPLICATIONS

This application claims the benefit of the U.S. Provisional Application No. 60/184,166, filed Feb. 21, 2000, which is hereby incorporated herein by reference in its entirety.

### FIELD OF THE INVENTION

The present invention relates generally to financial transaction processing, and more particularly, to a system and method for facilitating electronic bidding protocols between stable value fund managers and stable value contract issuers.

### BACKGROUND OF THE INVENTION

The financial industry provides a multitude of investment options for investors to manage and grow their financial resources. The different types and vehicles of investment continues to increase. With all of the different options available, individual investors often turn to managed plans or otherwise seek professional investment advice to help simplify investment decisions. In the workplace, companies and employers often provide ways to allow employees to invest a portion of their income, such as through a 401 (k) program, which is an investment vehicle facilitated by the tax code.

Investments range from conservative, essentially no-risk interest accounts to highly-volatile and risky financial endeavors. When availing such investment options, companies typically aspire to provide multiple investment choices for both those who welcome risk where potential return is great, as well as for the risk-wary participants who have an aversion to a high risk of financial loss. For this reason, company sponsored investment plans typically provide options for a range of plan participants who fall within this range.

One type of investment option that is relatively conservative is the guaranteed investment contract or “GIC.” Generally, a GIC is a debt instrument issued by an insurance company, often in a large denomination, and often bought for retirement plans. GICs are promises by insurance companies to repay principal plus a fixed interest rate by a specified date. The company that writes the contract, generally in insurance company or bank, promises the investor a certain interest rate over the life of the contract, which varies.

In recent years, the GIC market has been transformed from a single provider/single product environment to the greatly expanded multiproduct/provider stable value industry. The industry now offers a spectrum of new products and services provided by a variety of different issuers, including insurance companies, banks and fixed income money managers. In addition, third party intermediaries and professional money managers now have significant influence over investment selection and strategy. These third party intermediaries have substantially increased their purchase activity and dramatically improved the level of buyers sophistication.

Generally, a stable value fund is a type of low-risk investment fund that has proved to provide an appreciable return considering the virtually nonexistent risk of principal loss. While stable value funds used to invest only in GICs, now they also invest in government bonds and high-quality asset-backed securities and corporate bonds that offer the investor the ability to withdraw or transfer funds without market value risk (risk of principal loss as interest rates rise) or other penalty for premature withdrawal. An insurance policy or “wrapper” provides the stability, which is purchased from a bank or insurer, protects investor's principal, and locks in a return. The issuer of the investment contracts thus guarantees principal plus accumulated interest and an interest rate for a specified period of time.

Further diversification is achieved when contracts issued by various banks and insurers are pooled into larger funds. A stable value fund pools money of many investors, and uses it to buy a number of contracts from insurance companies or banks, i.e., the issuers. Under the terms of each contract, the issuer guarantees a regular rate of return for the length of the contract, and takes on two types of risk, namely investment risk and withdrawal risk. Investment risk is where the issuer invests the money in a portfolio of fixed income investments, such as government bonds or mortgages. If the returns on this investment are lower than what the contract issuer is paying you, the issuer still pays you the specified amount and takes the loss. If investment returns are higher, the issuer pockets the extra profit.

Withdrawal risk is determined based on the probability of the plan running short of liquid assets and needing to access a contract for a book value payment. At any point in time during the term of the contract, the value of the underlying assets may be above or below the book value, but the issuer always pays the plan book value. As a result, an issuer could make or lose money due to plan withdrawals. Therefore, it is very important to properly price that probability which requires careful and thorough analysis of the necessary underwriting data. The risk of a stable value contract can be judged by the rating held by the issuer; i.e., if it has a AAA rating, so does the contract.

As a result of this product diversity, the characteristics of stable value portfolios have also changed radically. The average portfolio today is much more complex in both structure and risk profile than its predecessor a decade ago. These complexities and high volumes of stable value transactions have caused inefficiencies in stable value portfolio management. Further, stable value managers (i.e., “buyers”) or independent buyers traditionally communicated all of the underwriting data to issuers in hardcopy paper format, such as by facsimile or regular mail. Stable value issuers (i.e., “sellers”) then had to re-enter this information into their internal system used for underwriting and pricing the contract that is being bid out.

Software applications have been used to assist in such transfers. One such software application, developed by the assignee of the instant application, provides an electronic communication system for facilitating financial transactions between money managers and issuers of investment contracts. Such a system is described in copending U.S. patent application Ser. No. 09/520,825, entitled “Electronic Communication System and Method For Facilitating Financial Transaction Bidding and Reporting Processes,” filed on Mar. 8, 2000 and assigned to the assignee of the instant application, the contents of which are incorporated herein by reference in its entirety. The system allows plan data to be uniformly collected, actively monitored and systematically analyzed. Data management utilities were included to provide data interfacing and consistency in data transfer between various computing systems.

The prior art system utilizes a central database as a repository for information, such that buyers could transfer information of interest to contract sellers, if and when the sellers would access the central database. The bidding process of prior art systems was reliant on exchanging paper documents, such as via fax, or by entry of data into spread sheets via software available to both the buyers and sellers.

It would be desirable to increase the efficiency of existing financial transaction systems, such as the bidding protocol between plan managers and plan issuers in the stable value industry. The present invention provides an on-line manner of facilitating bidding in this investment industry, which greatly increases the efficiency, flexibility and overall effectiveness of the transaction. The present invention therefore overcomes shortcomings of the prior art, and provides advantages over existing financial transaction systems.

### SUMMARY OF THE INVENTION

The present invention is directed to a system and method for financial transaction processing, and more particularly, to a system and method for facilitating electronic bidding protocols between stable value fund managers and stable value contract issuers.

In accordance with one embodiment of the invention, a method is provided for facilitating investment contract bidding between investment contract buyers and investment contract sellers. At least one buyer creates an electronic bid invitation, and designates sellers in which a responsive bid is desired. The electronic bid invitation is electronically dispatched to the designated sellers in order to prompt the sellers to furnish the bid. Electronic bid responses are submitted by the designated sellers back to the buyer in response to the electronic bid invitations. The buyer identifies the most favorable electronic bid response from all of the bid responses received. In one embodiment, all of the electronic bid responses are arranged to facilitate a comparative analysis of the bid responses. The seller who submitted the most favorable bid response is notified through an electronic transmission that the buyer wants to enter into an investment contract with the winning seller, at terms substantially defined in the seller's winning bid response.

In accordance with another embodiment of the invention, a method for facilitating investment contract bidding between stable value managers and issuers of stable value investments is provided. A network allows the managers and issuers to electronically communicate. The method includes providing a manager user interface to accept manager entry of bid parameters for at least one investment contract, and to accept manager entry of a designation of issuers in which investment contract bids are solicited. Bid invitations are transmitted via the network, where the bid invitations include bid parameters that help the issuers determine how to respond to the bid solicitation. The bid invitations are transmitted to each of the designated issuers in which the investment contract bids are solicited. An issuer user interface is provided to accept entry of bid response information by the designated issuers for the investment contract. Bid responses, including the bid response information, are transmitted back to the manager via the network. A manager selection user interface is provided to the manager to facilitate a comparative analysis of the bid response information received from all of the issuers, and to allow the manager to select at least one of the bid responses as a winning bid.

In accordance with another embodiment of the invention, a transaction processing system is provided for facilitating investment contract bidding between investment managers and investment contract issuers. The system includes a manager computing device, at least one issuer computing device, and a network coupled to the manager and issuer computing devices to facilitate transmission of bid solicitations and bid responses therebetween. The manager computing device facilitates creation of bid solicitations that include bid parameters for at least one investment contract, and facilitates designation of one or more contract issuers to receive the bid solicitations. The manager computing device transmits the bid solicitations to each of the designated contract issuers, and allows the manager to comparatively analyze bid responses subsequently provided by the designated contract issuers. Through the manager computing device, the manager selects at least one of the bid responses as a winning bid response. The issuer computing device allows bid solicitations to be received, and allows the issuer to enter bid response information in response to the bid solicitation in order to create the bid responses. The issuer computing device also transmits the bid responses back to the manager. In this manner, electronic bidding between the manager and issuer of investment contracts is efficiently and effectively carried out.

### BRIEF DESCRIPTION OF THE DRAWINGS

FIG. 1 illustrates a typical relationship between various participants in a stable value investment program in accordance with the present invention;

FIG. 2 is a system level diagram illustrating one manner of facilitating the electronic transfer of plan data between managers and issuers in accordance with one embodiment of the present invention;

FIG. 3 is an illustration depicting the various components associated with a typical user computing system;

FIG. 4 is a block diagram illustrating one manner in which managers transfer plan information to issuers;

FIG. 5 is a flow diagram illustrating one embodiment of a financial transaction bidding process in accordance with the present invention;

FIG. 6 is a flow diagram illustrating an embodiment in which the bidding process in accordance with the present invention may be applicable to managers and issuers of stable value contracts;

FIG. 7 illustrates a more specific example of a bidding process in accordance with the present invention;

FIG. 8 illustrates an embodiment of the bidding process facilitated through the Internet in accordance with the principles of the present invention;

FIG. 9 illustrates a generic user interface providing buyers, such as stable value portfolio managers, an interface to the electronic bidding system of the present invention FIG. 10 illustrates an a user interface presented to a buyer/manager upon initiating the creation/loading of a bid request in accordance with one embodiment of the invention;

FIG. 11 illustrates a user interface that allows the buyer/manager to create a copy of an existing bid request to formulate a new bid request in accordance with one embodiment of the invention;

FIG. 12 illustrates a user interface screen presented upon selecting a blank bid form in accordance with one embodiment of the invention;

FIG. 13 is a user interface presented to allow buyers/managers to select from a predetermined plurality of potential contract issuers in accordance with one embodiment of the invention;

FIG. 14 is a user interface presented upon initiation of the review and add email recipients function to allow seller/issuer e-mail addresses to be specified;

FIG. 15 is a user interface screen used by buyers/managers to generate bid requests in accordance with one embodiment of the invention;

FIG. 16 is an example of a user interface screen used by buyers/managers to preview the bid request in the format in which the issuers will be presented;

FIG. 17 illustrates a user interface presented to a buyer/manager upon initiating a check bid receipt status in accordance with one embodiment of the invention;

FIG. 18 illustrates a selectable list from which the buyer/manager can select the particular bid name to review confirmations sent by the sellers/issuers indicating that they received the bid request and whether the sellers/issuers intend to respond to the bid request;

FIG. 19 provides a user interface that is presented to the buyer/manager upon selection of one of the bid names in the selectable list of bid receipts in accordance with one embodiment of the invention;

FIG. 20 illustrates an example of a user interface according to the invention which is presented to a buyer/manager upon initiating the review and analyzation of bid results;

FIG. 21 is an example of a user interface in which a manager can review bid responses in accordance with one embodiment of the invention;

FIG. 22 is a user interface in which a manager can select bid winner(s) from the sellers/issuers submitting bids in accordance with one embodiment of the invention;

FIG. 23 illustrates an example of a user interface presented to a buyer/manager upon creating confirmation and results memorandums to the sellers/issuers;

FIG. 24 is an example of a user interface of a confirmation summary screen in which information as to the particular agreed-upon bid may be presented;

FIG. 25 illustrates an example of a bid results memo used to identify the winning bids and issuers for the various plans;

FIG. 26 illustrates a generic user interface providing sellers, such as stable value contract issuers, an interface to the electronic bidding system of the present invention;

FIG. 27 illustrates an example of a user interface presented to a seller/issuer in connection with responding to a manager bid request;

FIG. 28 provides a user interface of the categorized bids that can be selected by the issuer for review and/or response in accordance with the invention;

FIG. 29 is an example of a user interface screen for use by issuers in responding to manager bid requests;

FIG. 30 illustrates an embodiment of a user interface through which the issuer can acknowledge receipt of the bid request and notify the manager of the issuer's intent to bid in accordance with the invention;

FIG. 31 illustrates an exemplary user interface presented to the seller/issuer in which the seller/issuer can enter bids for each of the bid request scenarios availed by the requesting buyer/manager;

FIG. 32 is an example of a text entry field user interface through which issuers may input any type of text to provide to the manager;

FIG. 33 illustrates an example of a user interface according to the invention which is presented to a seller/issuer in connection with the review of confirmation summaries; and

FIG. 34 illustrates an example of a view results memo interface that presents the issuer with a list of closed bids to allow the issuer to review the results for bids that have been submitted and analyzed.

### DETAILED DESCRIPTION OF THE ILLUSTRATED EMBODIMENTS

In the following description of the various embodiments, reference is made to the accompanying drawings which form a part hereof, and in which is shown by way of illustration various embodiments in which the invention may be practiced. It is to be understood that other embodiments may be utilized, and structural and functional modifications may be made without departing from the scope of the present invention.

The present invention relates generally to financial transaction processing, and more particularly to a system and method for providing electronic bidding between buyers and sellers of investment contracts. For example, buyers of stable value investment contracts, i.e., stable value portfolio managers, can submit bid requests and receive bids from any selected sellers of stable value investment contracts, i.e., issuers of the stable value investment contracts. This bidding protocol is managed electronically using computing equipment and networking principles, thereby providing speed and efficiency in a paperless environment.

As will be described more fully below, the following description is provided in connection with a stable value investment program in accordance with the invention. It will be recognized, however, that the present invention is applicable to other investment contracts and financial transactions, and is therefore not limited to the specific example embodiments provided. Because an understanding of the transactions between managers and issuers in the stable value industry facilitates an understanding of the invention, these relationships and transactions are described below.

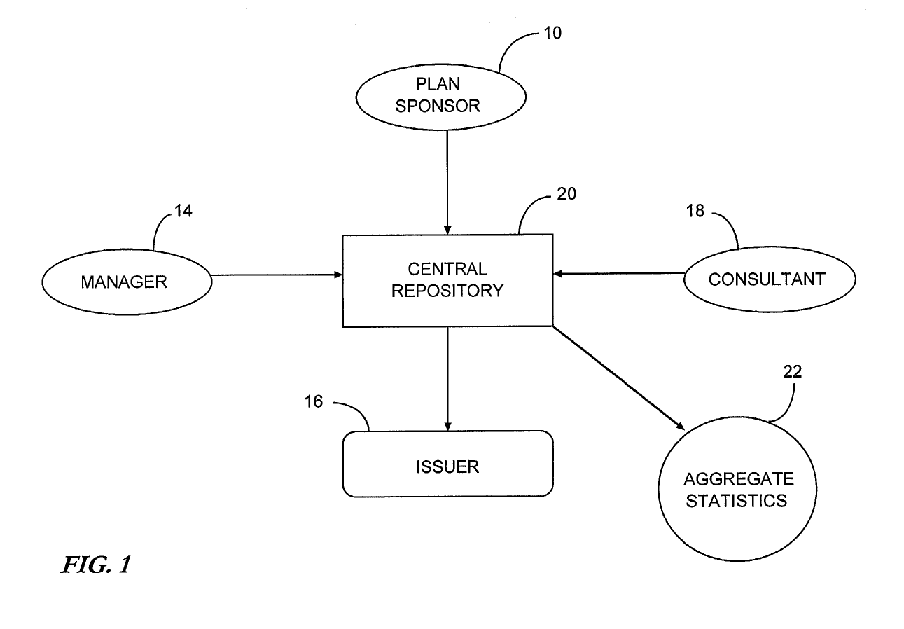

FIG. 1 illustrates a typical relationship between various participants in a stable value investment program. An individual company, such as the ABC Company, is referred to as a plan sponsor 10. Plan sponsors 10 are the “sponsors” of an investment scheme, such as a retirement plan, on behalf of its employees or participants 12 of the plan. A retirement plan is generally a tax-qualified plan under which the amount of the participant's benefit will vary dependent on the amount of employer and employee contributions made to the participant's account and the investment earnings credited thereon. Most defined contribution plans have participant-directed investment choices. The retirement plan typically includes various investment options of different types of funds, one of which may be a stable value fund.

The plan sponsor, such as ABC company, can either manage plan assets on its own, or it can retain the services of a professional investment manager 14. The investment manager 14 is a fiduciary who has the power to manage, acquire or dispose of certain plan assets. A stable value manager 14 therefore places and manages the stable value assets in a contribution plan and assumes the fiduciary responsibility for this management. Managers 14 are considered data providers to issuers 16, since managers 14 deliver all the necessary data, i.e., “plan information,” for competitive contract rates to a wide range of contract issuers.

The stable value manager 14 may also be referred to as a “buyer,” since in the generic sense the manager assumes the responsibility for purchasing investment contracts and managing the portfolio of investments. The plan sponsor 10 may itself manage its portfolio directly, thus bypassing the need for a manager 14, and in this case the plan sponsor is considered an independent buyer. This may be the case where the plan sponsor is a large corporation that has established a retirement plan for its employees to use as a savings vehicle for retirement investing. A consultant 18 may be also retained by the company, which is an organization to provide professional advice to the corporate retirement plan by assisting individuals in charge of the plan with prudent investment decisions.

The managers, or buyers, purchase general account contracts and synthetic contracts from stable value issuers 16 in order to build a portfolio with the dollars employees have contributed. The stable value products are insurance-based products and must be underwritten like any other insurance product such as life, health and auto insurance. Managers 14 must supply the stable value issuers 16, also referred to as “sellers,” with a significant amount of information on the characteristics of the company sponsored plan in order for the seller 16 to underwrite the risks that they are undertaking, so that a guaranteed rate of return on the contracts can be determined. This information, i.e., the plan information, includes general plan information such as contributions, company match rules and withdrawal provisions. The plan information also includes cash flow data on the stable value fund investment option that provides the inflows and outflows of all company employee dollars into this investment option, as well as other investment options offered and historical balances.

Once all the underwriting information is distributed from the buyer 14 to the seller 16, a manager/buyer 14 can request quotes for a specific plan. A manager will typically attempt to structure contract purchases in a predetermined dollar range on various maturity scenarios, and will collect bids from a number of different issuers/sellers 16. Upon receipt of all of the issuer bids, a manager begins the analysis of all bids and selects a winner. There is often some verbal dialog to negotiate the final rate, and when agreement is reached, a deal is typically memorialized on paper, traditionally via facsimile confirmation.

Managers 14 enter the plan information into a central database 20 via software to facilitate this process. The manager electronically builds a file for the issuer and transfers it to the issuers electronically. The stable value issuers 16 also have software to retrieve the file and bring it into its own database. Faxing or mailing reports is unnecessary using the central repository 20, and both the stable value managers and issuers have all of the data stored in an electronic database for easy access and analysis. From the central database 20, aggregate statistical information 22 can be generated for analysis by parties having access to the database.

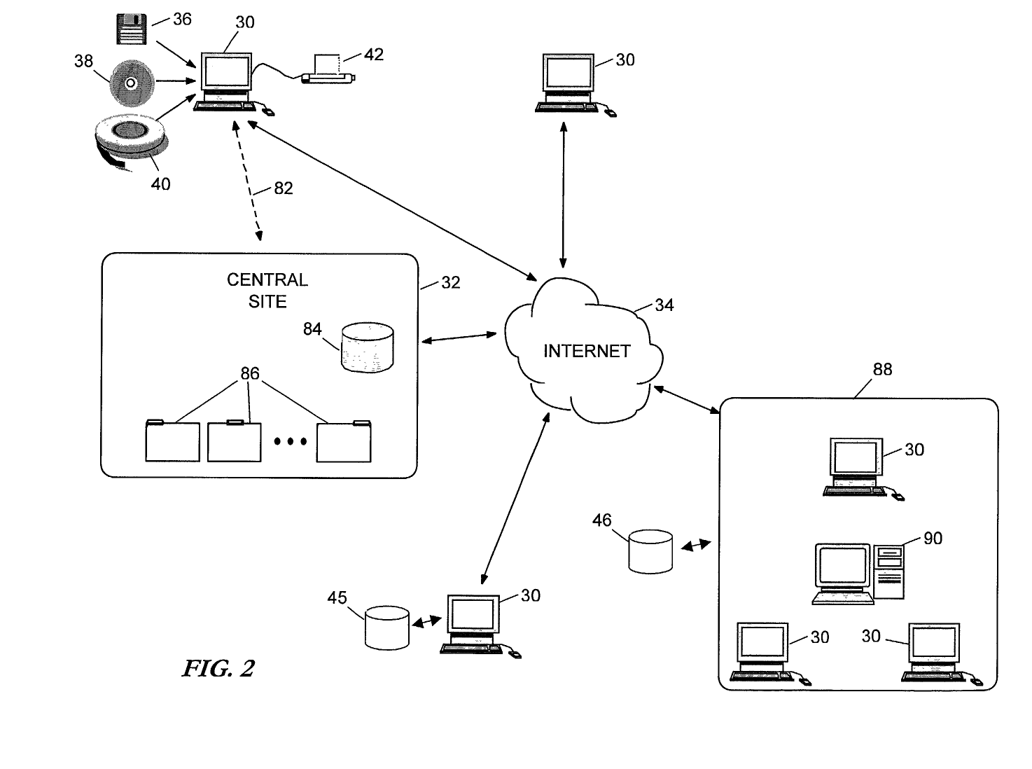

FIG. 2 is a system level diagram illustrating one manner of facilitating an electronic transfer of plan data between managers and issuers. One or more computing systems 30 can communicate with one another, and with the central site 32, via electronic transfer of information. This can be accomplished, for example, via the Internet 34. Each computing system 30 may include one or more various types of storage mediums to store program instructions that control the processing functions and actions taken by the computing system 30, such as diskette 36, CDROM 38, or tape 40. Reports and other documentation may be printed on printer 42.

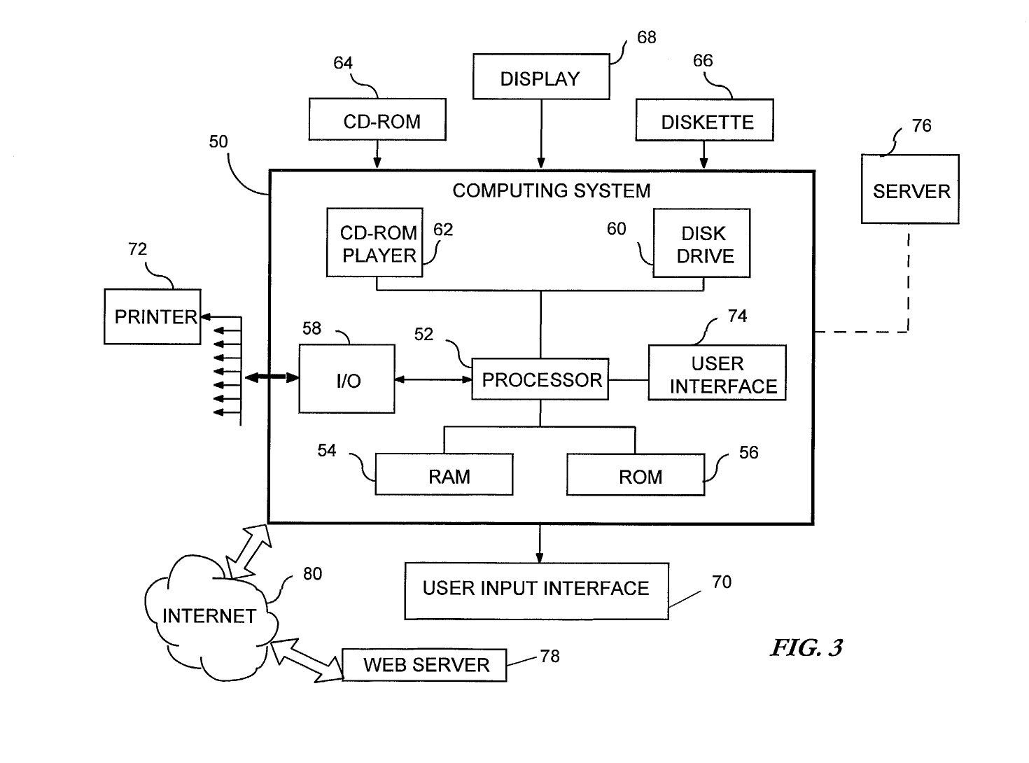

Each of the user computing systems 30 are suitable for performing the functions in accordance with the present invention. Referring now to FIG. 3, an illustration is provided that depicts the various components associated with a typical user computing system 50. The computing system 50 typically includes a central processor (CPU) 52 coupled to random access memory (RAM) 54 and read-only memory (ROM) 56. The processor 52 communicates with other internal and external components through input/output (I/O) circuitry and bussing 58. The computing system 50 may also include one or more data storage devices, including hard and floppy disk drives 60 and a CD-ROM drive 62. In one embodiment, software containing application software, such as file management or command shell programs, may be stored and distributed on a CD-ROM 64, diskette 66, or other medium that may be inserted into, and read by, the CD-ROM drive 62 or the disk drive 60 respectively. The computing system 50 is also coupled to a display 68, a user input interface 70 such as a mouse and keyboard, and a printer 72. The user typically inputs and outputs information by interfacing with the computing system 50 through the user interface 74, which interacts with user input interface 70 and display 68. The computer may optionally be connected to network server 76 in a local network configuration. The computer may further be part of a larger network configuration as in a global area network (GAN) such as the Internet. In such a case, the computer accesses one or more web servers 78 via an internet 80.

It should be recognized that the “user interface” generally includes the devices that allow the user to interface with the computer, both from an input and output standpoint. Thus, input mechanisms are part of the user interface, such as a keyboard, mouse, trackball, joystick, touch screen, verbal or other audio command input, etc. These and other input user interface devices are known in the art. Similarly, output user interface devices, such as a display or monitor, audio output, etc. may be used in connection with the invention, and are also well known in the art.

Referring again to FIG. 2, the information communicated may be transferred via the Internet 34 to and from the central site 32 so that managers and issuers can transmit and receive data to and from one another. Optionally, a computing system 30 may have a direct electronic link to the central site 32, as depicted by dashed line 82. The central site 32 includes database storage 84, which may be physically and/or logically partitioned into individual folders 86 corresponding to issuers who are authorized to view, download, or otherwise process the data in its respective folder 86. Other computers 30 arranged in a network 88 via a server 90 may also be coupled to the central site 32, preferably via the Internet 34.

Managers and issuers may maintain large system databases, such as the databases 45 and 46. These databases typically store information for record keeping and tracking for many plans relating to various funds, of which stable value funds may be only a portion. The stored information relates to all information on individual participants in all of the various funds and plans available, and on the funds and plans themselves. In one example, databases 45 and 46, or separate databases, are kept for information relating to the particular funds associated with the data to be transmitted between managers and issuers for purposes of conducting financial transactions for a particular fund group, such as stable value funds. A subset of data may be exported from one database, such as database 45, and imported into another database, for ultimate transmission to central site 32 where the information is retained as depicted by database 84. Each computing system 30, 88 may maintain multiple databases, one of which includes the plan information relating to the present invention.

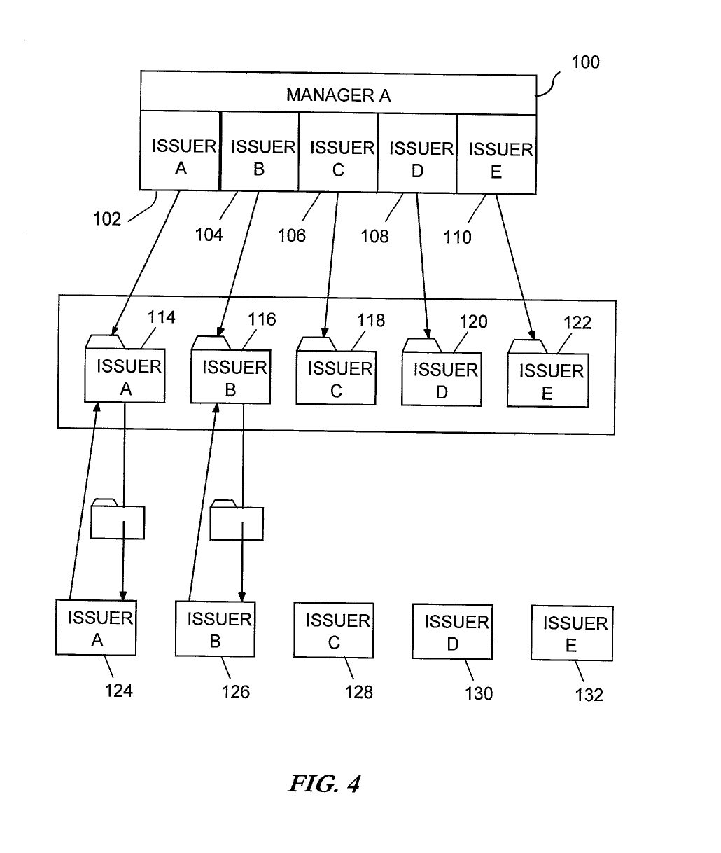

FIG. 4 is a block diagram illustrating one manner in which managers transfer plan information to issuers. A manager, labeled Manager A 100 can transfer plan information to one or more of a plurality of identified issuers, labeled identified Issuer A 102, identified Issuer B 104, identified Issuer C 106, identified Issuer D 108, and identified Issuer E 110. Managers can transmit the plan information to a central repository, such as FTP (Internet) site 112, or the central repository 20 shown in FIG. 1.

At the central repository, Internet site 112 in this example, transmitted files rest in a separate folder for each authorized user, such as the Issuer A Folder 114, Issuer B Folder 116, Issuer C Folder 118, Issuer D Folder 120, and Issuer E Folder 122. Only issuers with authorized access will be able to download the plan information from their designated folder at the central repository. Each issuer, such as Issuer A 114, Issuer B 116, Issuer C 118, Issuer D 120, and Issuer E 122, may be provided with a unique access code that allows them to complete the data transmission process by uncompressing and decrypting downloaded files. In this manner, managers determine for each plan which issuers are allowed to receive information for that plan. In the example of FIG. 4, issuers A 114 and B 116 have been targeted to receive information. Issuers may be notified electronically when plan information is resident in their corresponding issuer folder, such as via e-mail. Alternatively, the issuers can monitor for information in their respective issuer folders. This system provides for the uniform collection, active monitoring, and systematic analysis of plan data by issuers.

Facilitating and carrying out such financial transactions, such as those effected in the stable value industry, may be determined in a manner described herein and in copending U.S. patent application Ser. No. 09/520,825, entitled “Electronic Communication System And Method For Facilitating Financial Transaction Bidding And Reporting Processes,” filed on Mar. 8, 2000, which is assigned to the assignee of the instant application, the contents of which are incorporated herein by reference.

As described generally above in connection with the transactions between buyers and sellers in the financial industry, “bidding” is an important part of the transaction process. In accordance with the present invention, bidding is effected using electronic transmission techniques, thereby expediting the bidding process and maximizing the efficiency for both managers and issuers of investment contracts such as stable value investment contracts.

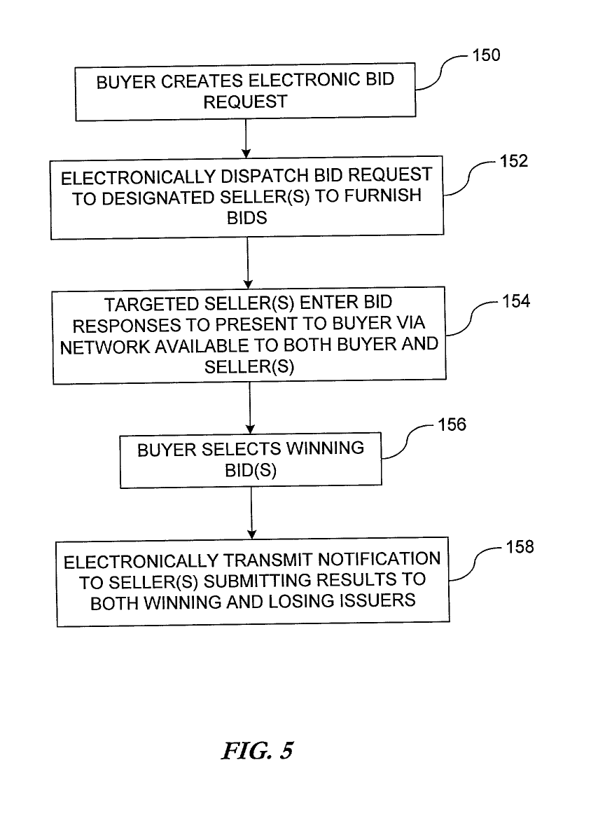

Referring now to FIG. 5, a flow diagram is provided illustrating one embodiment of a financial transaction bidding process in accordance with the present invention. A buyer, such as a manager of a stable value portfolio, creates an electronic bid request as depicted at block 150. The bid request is essentially an invitation to the investment contract sellers to provide a quote for the investment contract. The buyer can designate multiple potential sellers (e.g., issuers of stable value contracts) as recipients of the electronically-generated bid request, which can then be dispatched 152 to the designated sellers. In response, the targeted sellers can enter bid responses as shown at block 154, which are ultimately presented to the buyer via a network available to both the buyer and sellers. For example, the Internet is one such network facilitating the entry and transmission of bid responses from the targeted sellers back to the requesting buyers. When one or more of the targeted sellers has entered their bid responses and availed them to the requesting buyer, the buyer can select 156 the winning one or more bids from the various bid responses furnished by the sellers. In one embodiment, each of the resulting bid responses are arranged in a manner that facilitates easy comparison, and also highlights particular bids meeting certain criteria such as the most favorable bid. Once the buyer has selected one or more winning bids, a notification can be electronically transmitted 158 to each of the sellers that submitted a bid, whether the bid is ultimately a winning or losing bid in the eyes of the buyer. For example, a winning notification can be sent to winning sellers to confirm the bid furnished by that particular seller, while a more generic result notification or losing notification can be sent to the sellers whose bids were not identified as winning bids by the buyer. In one embodiment, the general results are dispatched to all selected issuers, including both the winning and losing issuers, while the winning confirmations are sent only to the winners. In another embodiment, the general results can be sent to all responding issuers, and not to those issuers who failed to respond. As can be seen, a variety of different manners of notifying the winning and losing issuers are contemplated by the invention.

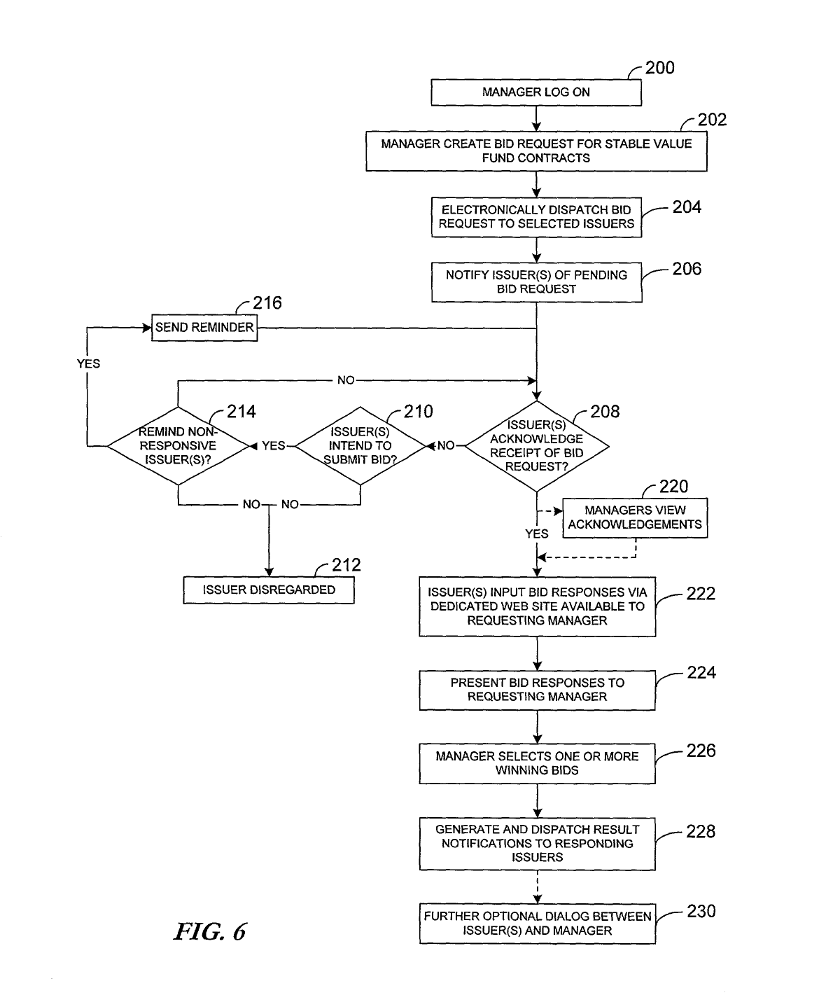

FIG. 6 is a flow diagram illustrating an embodiment in which the bidding process in accordance with the present invention may be applicable to managers of stable value portfolios and issuers of stable value contracts. In this particular embodiment, a manager of the stable value portfolio logs on 200 to the system, which in one embodiment is an Internet web site. The manager creates 202 bid requests for stable value fund contracts, and electronically dispatches 204 the bid requests to selected issuers of stable value funds. The customized bid request may include information such as the bid due date and time, an identification of the issuers to receive the bid, the inclusion of qualifying language in text entry fields, and the like. In one embodiment, the electronic bid request is sent via e-mail, which notifies 206 the issuers of the pending bid request. In other embodiments, the issuer may be notified 206 of the pending bid request by way of other electronic means, such as an through the web site, via an electronic calendar or audible indication, or other means of notifying the issuer.

The issuers can acknowledge receipt of the bid request by logging onto the system, such as the Internet web site, and initiating an acknowledge message and information relating to the issuer's intent to bid which is sent back to the requesting manager. This acknowledgment can be an indication available through the web site itself, or alternatively could trigger an e-mail to the requesting manager. If the issuer has not acknowledged receipt of the bid request as determined at decision block 208, and the issuer does not intend to submit a bid as determined at decision block 210, that particular issuer will thereafter be disregarded or otherwise will simply not be part of the bidding process. Otherwise, if the issuer does intend to submit a bid, and therefore does not express a desire to be disregarded from the bidding process, the manager has the ability to remind the issuer that a bid request is pending. If the manager chooses not to remind the nonresponsive issuer of the pending bid request, as determined at decision block 214, the issuer can be disregarded 212. Otherwise, if the manager chooses to remind the nonresponsive issuer of the pending bid request, a reminder is sent 216, thereby again prompting the issuer to acknowledge receipt of the bid request. In one embodiment, the reminder can be generated by the managers via selection of a particular button on a graphical user interface (GUI) available through the web site software. In this embodiment, clicking the button automatically dispatches an e-mail reminder to only those issuers who have not yet responded to the bid.

Optionally, the managers can view the issuer receipt confirmations and the issuers intend-to-bid notifications in an aggregate format as shown at block 220. The issuers input their bid responses on-line via the dedicated web site available to the requesting manager as shown at block 222. In one embodiment, the issuers have the ability to add qualifying text to their bid in a custom text box area. The issuers entire bid may be instantaneously displayed in the managers custom grid, which was created with the initial bid request. In this manner, the bid responses are presented 224 to the requesting manager. At the time the bid is due, managers have access to a complete comparative analysis on-line. In addition they have the option to perform an in-depth analysis by downloading all of the information into a spreadsheet on the local computer with the click of a button.

After review and analysis of the bid data, managers select the bid or bids of their choice that the manager has determined is the winning bid or bids as shown at block 226. Result notifications are generated and dispatched 228 to each of the responding issuers. In one embodiment, an immediate confirmation summary is generated, and notification of manager acceptance is provided to the winning issuer(s) via e-mail. Once winners are selected, managers can automatically send out a deal summary to issuers that provides an update as to the decisions made. Losing issuers can be notified that they failed to win the bid, and can be notified of other information such as the winning quote. Further optional dialog may occur between the issuers and the manager, as shown at block 230. For example, the winning issuers may reply to the manager to authorize the terms of the contract.

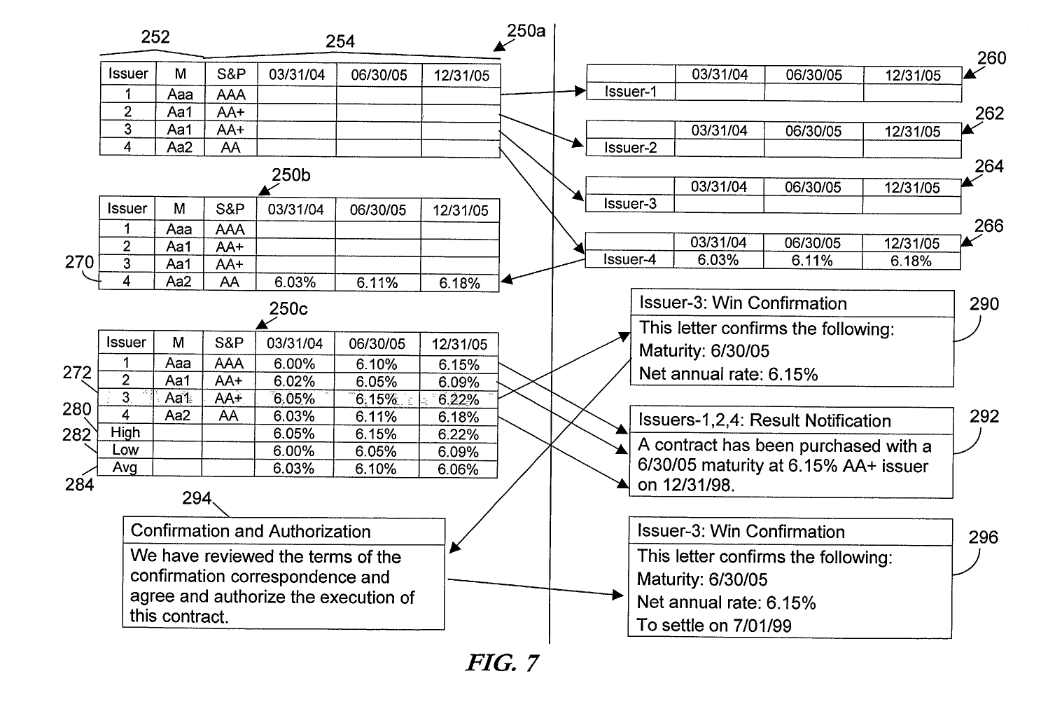

FIG. 7 illustrates a more specific example of the bidding process in accordance with the present invention. This embodiment provides an example of how the manager and issuers electronically communicate with one another to carry out the desired bidding. The manager creates a bid request grid or template 250a, which includes a number of issuers 252 in which the manager would like to obtain a bid. Other information such as ratings and contract maturity periods, generally depicted by columns 254, can be included in the bid request grid 250a. The bid requests associated with the bid request grid 250a are then sent to each of the particular issuers, as depicted by individual bid requests 260, 262, 264, 266. For example, upon completion of the bid request grid 250a, the manager can simply initiate the transmission of each of the bid requests 260, 262, 264, 266 with the click of a button via the user interface, which causes individual e-mails to be generated to the targeted issuers of the bid requests.

It should be recognized that the presentation of the bid information to the managers need not be presented in a textual grid as shown in the example of FIG. 7, but rather may be presented in any format desired. For example, other text formats, graphical formats, audio formats, etc. may be used rather than the grid presentation depicted. It is desirable, however, to present the information in a manner that the responsive bids can be easily referenced and compared to one another. FIG. 7 simply illustrates one particular manner in which such information may be presented to the manager.

The targeted issuers respond to the bid requests by providing the requesting manager with an electronic bid, which, as shown in bid request grid 250b, now includes updated information in row 270 of columns 254. The updated information reveals that Issuer-4 has responded to the bid request. As other issuers respond, other fields corresponding to the particular responding issuer will be presented in columns 254.

When the issuers have responded to the bid request, or the bidding period has expired, the manager can collectively view all of the bids, as shown in the bid request grid 250c. As can be seen by entries on columns 254, all issuers have responded to the manager's bid request. Other information helpful to the managers to make a selection can be provided, such as the high bid, low bid and average bid presented on rows 280, 282 and 284. In this example, Issuer-3 provided the highest stable value contract bid for each of the contract periods as determined by viewing the high bid row 280 and the Issuer-3 row 272. The manager selects the winning bid, such as by highlighting the bid via the GUI, and creates an initial confirmation summary, such as a confirmation summary e-mail depicted by block 290. A “results memorandum” may also be sent out to non-winning issuers, such as the example email 292. The winning issuers can reply to authorize the terms of the confirmation summary, adding details as necessary. An example confirmation and authorization e-mail 294 is provided, which indicates that the winning issuer has reviewed the terms of the confirmation correspondence, and agrees and authorizes the execution of the contract. The manager can then send a final confirmation 296 to the winning issuer(s) to confirm receipt of the issuer's authorization, and to reiterate terms of the contract.

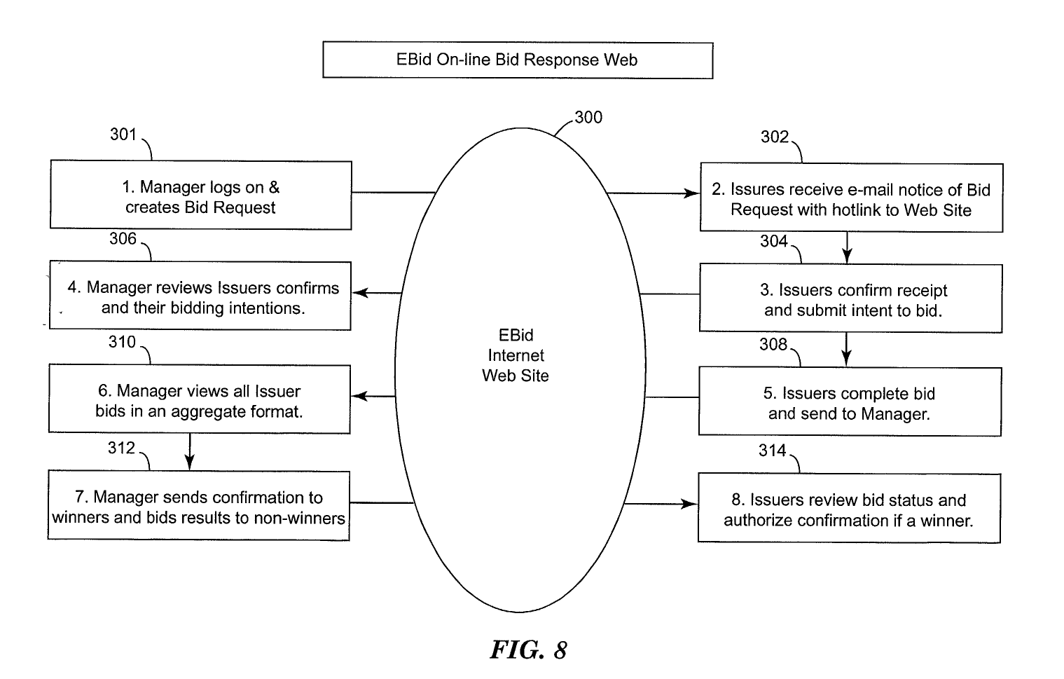

FIG. 8 illustrates an embodiment of the bidding process facilitated through the Internet, in accordance with the principles of the present invention. The communication flow of the embodiment of FIG. 8 is facilitated by an Internet web site 300 to which both the buyers (e.g., managers) and sellers (e.g., issuers) can access to carry out an on-line bidding transaction process in accordance with the invention. The manager logs on to the Internet web site 300, and creates a bid request as seen at block 301. The issuers receive a notice, such as an e-mail notice as shown at block 302, of the bid request that in one embodiment of the invention includes a hyperlink to the Internet web site 300. Through the Internet web site, the issuers can confirm receipt of the bid request and submit an “intent to bid” to the requesting manager as set forth at block 304. The manager can review 306 the receipt confirmations and bidding intentions provided by the issuers.

The issuers subsequently complete the requested bid and send it to the manager via the Internet web site 300 as shown at block 308. In response, the manager can view 310 all issuer bids aggregately, i.e., in a comparative manner. The bid or bids that appear most desirable to the manager are selected as the winning bids, and a manager sends 312 confirmation to the winners, and may also send the bid results to the non-winning issuers. The issuers can then review the bid status sent by the manager, and can authorize confirmation if that particular issuer has been selected as an issuer of a winning bid, as shown at block 314.

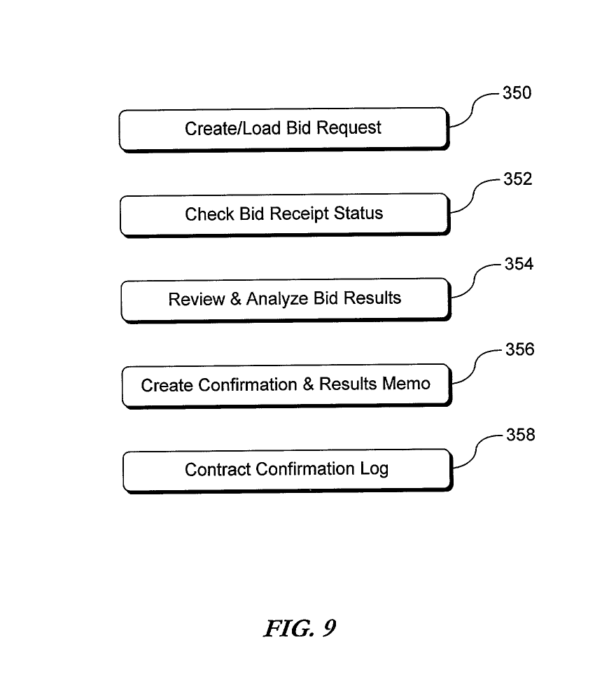

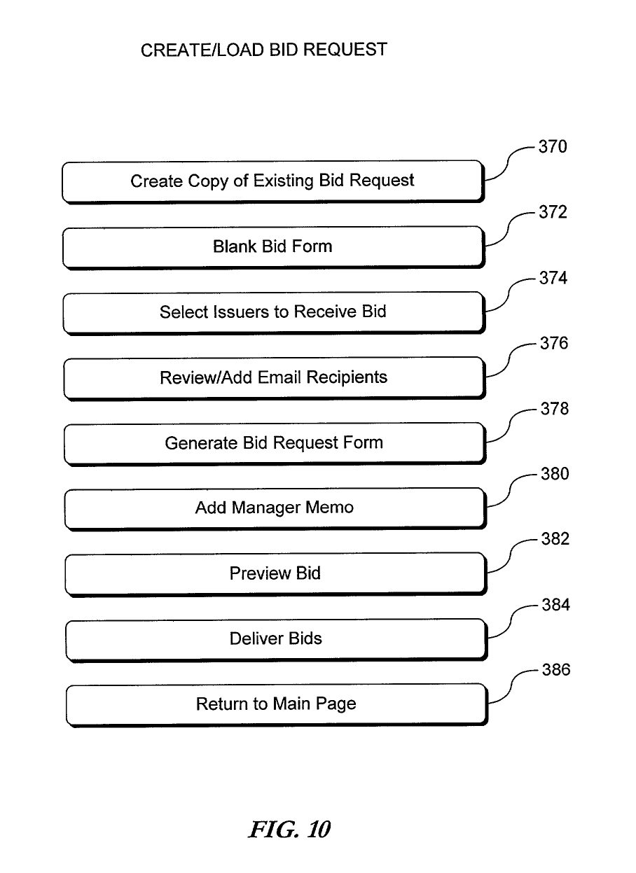

FIG. 9 illustrates a generic user interface providing buyers, such as stable value portfolio managers, an interface to the electronic bidding system of the present invention. The example user interface in shown in FIG. 9 includes a graphical user interface (GUI) having a plurality of graphical buttons or icons that can be selected by the manager. In the example of FIG. 9, the manager can select a button to create or load a bid request 350, check the bid receipt status 352, review and analyze the bid results 354, create confirmation and results memorandums 356, and view the contract confirmation log 358.

Upon selection of the “create/load bid request” button 350, a second tier of user interface buttons or icons may be presented to the manager such as that depicted in FIG. 10. The manager has a plurality of selectable buttons to choose from when creating or loading a bid request, including creating a copy of an existing bid request 370, creating a bid request from a blank bid form 372, selecting the particular issuers to receive the bids 374, reviewing and adding e-mail recipients 376, generating bid request forms 378, adding a manager memo 380, previewing bids 382, delivering bids 384, and returning to the main page 386. The selectable buttons provided in FIG. 10 are representative of the types of actions available to managers in connection with creating and loading bid requests. The examples, however, are for illustrative purposes only, as a reduced number or an additional number of options may alternatively be available to the manager.

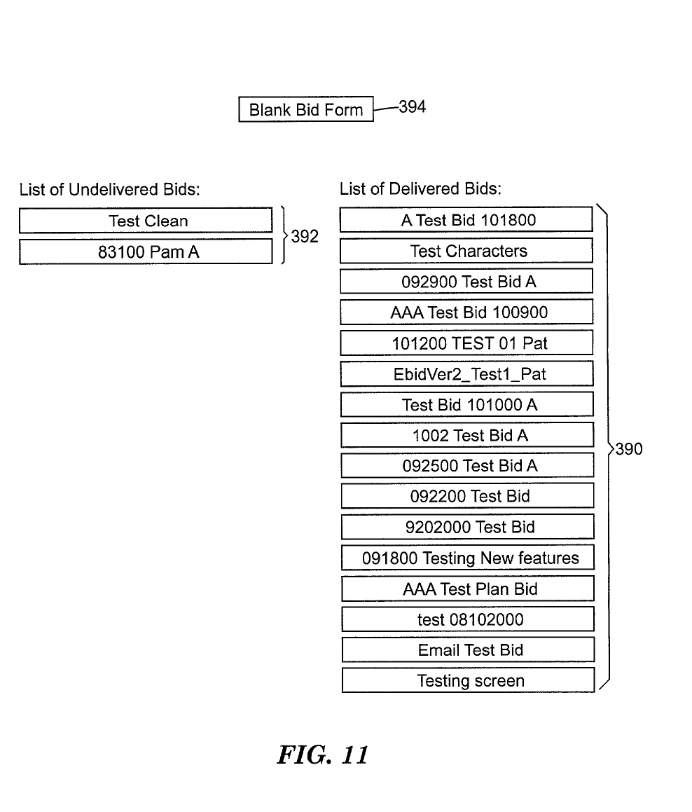

Various examples of different user interfaces for carrying out functions associated with creating or loading bid requests are provided in the following drawings. For example, FIG. 11 illustrates a user interface that allows the manager to create a copy of an existing bid request to formulate a new bid request. In order to create a copy of an existing bid request, the manager selects an existing bid request from a list of delivered bids 390 or list of undelivered bids 392. The undelivered bids 392 represent those bid requests that have not yet been delivered to their targeted issuers. The delivered bids 390 represent those bid requests that have already been delivered for the current or a previous bid request event. A blank bid form button 394 may also be provided on the user interface that allows a copy of an existing bid request to be created. Therefore, a blank bid form may be presented to the manager via user interface button 372 shown in FIG. 10, or the blank bid form button 394 shown in FIG. 11. Upon selection of one of the delivered or undelivered bids, information relating to these selected bid will be presented to be manager. The manager can review this information, and decide whether or not to create a copy of the particular bid request. The manager may also be presented with the option of deleting that particular bid request, or confirming, verifying, requesting clarification, or performing other functions relating directly to that particular selected bid request, instead of or in addition to using that particular bid request as a template for a new bid request.

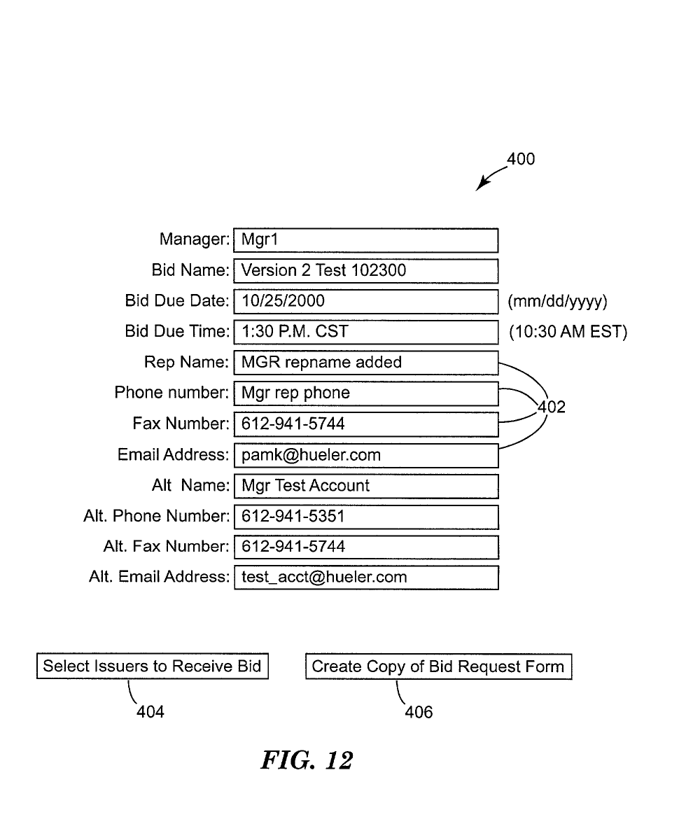

FIG. 12 illustrates an example user interface screen 400 made available by selecting the blank bid form button 372 or 394. Initiating a blank bid form presents the buyer/manager with a plurality of data entry fields, e.g., fields 402, in which a new bid request can be created from scratch, such as the data entry fields shown in FIG. 12. These data entry fields may be configured to receive information such as identification of the manager, a bid name, a bid due date, telephone, fax and other contact numbers, etc. Also included on screen 400 are user interface buttons, such as buttons 404 and 406, which directly provide the manager with buttons that would otherwise be available to the manager by returning to a previous user interface screen. For example, a button 404 allowing the manager to select the issuers to receive the bid may be provided, which is analogous to the user interface button 374 of FIG. 10. Similarly, and icon to allow the manager to create a copy of the bid request form on screen 400 is provided via icon 406.

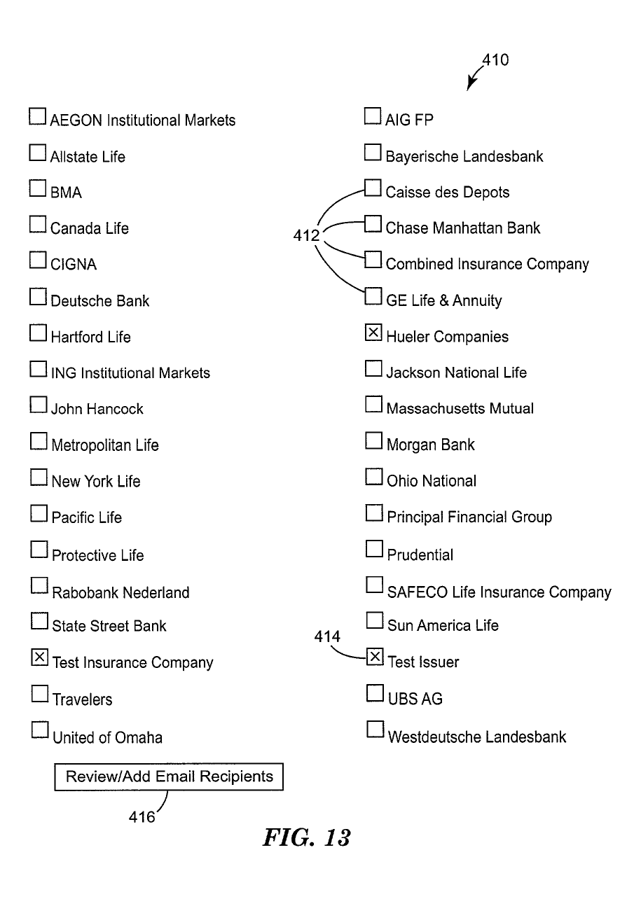

FIG. 13 is an example user interface 410 presented upon selection of the “select issuers to receive bid” button 374 of FIG. 10. In this example, a plurality of potential issuers, e.g., 412, are presented to the manager so that the manager can select which of the issuers the bid request is to be presented. Using the user interface, the manager selects one or more of the potential issuers, such as by clicking in a box 414 associated with the respective issuer. Other user interface buttons, such as the “review and adding e-mail recipients” button 416, can be provided on the user interface screen 410. Such a user interface button can be provided where it is a logical next step in the bid request creation process, without requiring the user to move back in the user interface hierarchy to the button 376 shown in FIG. 10.

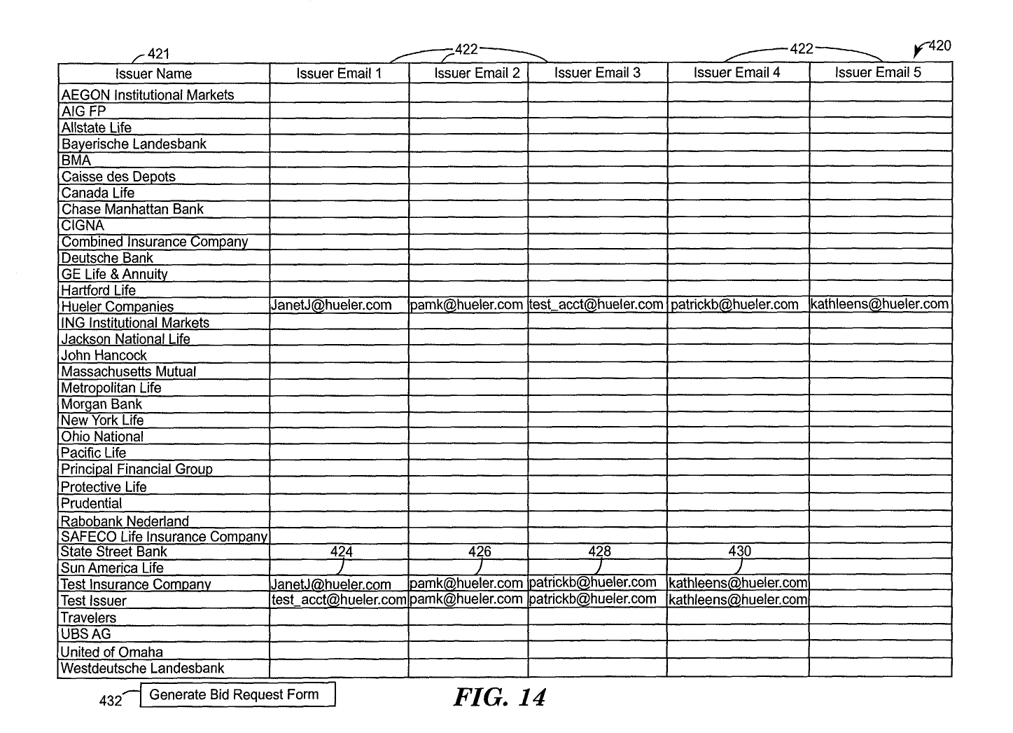

FIG. 14 is an example user interface 420 presented upon selection of the “review and add e-mail recipients” button 376 discussed in connection with FIG. 10. For each of the various issuers 421 selected via the user interface 410 of FIG. 13, the appropriate e-mail recipients are automatically, or manually, loaded into one of a plurality of e-mail entry fields 422. In this manner, each of the particular e-mail recipients associated with the particular issuer, such as recipients 424, 426, 428, and 430, will ultimately receive the bid request when dispatched to that corresponding issuer. Other user interface buttons, such as the “generate bid request form” button 432, may be included on the user interface 420.

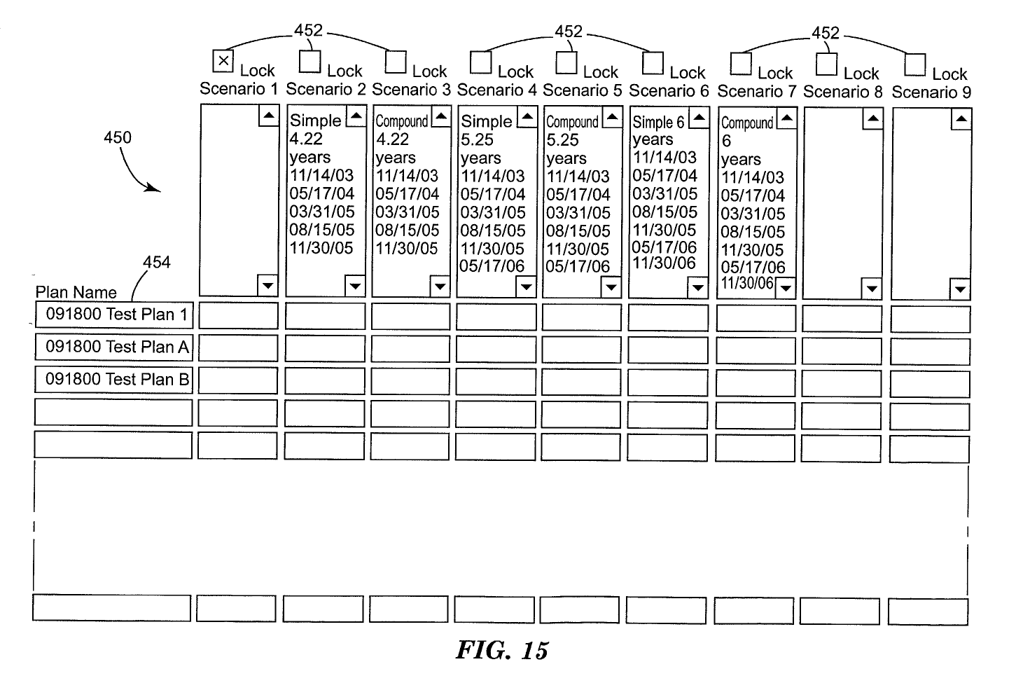

Selection of the “generate bid request form” button 378 shown in FIG. 10 presents a user interface screen 450 used to generate the bid request as shown in FIG. 15. Included in each of a plurality of bid request columns 452 are different scenarios in which bids are requested from the selected issuers. For example, the different scenarios may be directed to different types of stable value funds, different maturity dates, etc. Issuers, upon receipt of such a bid request, can enter the appropriate information corresponding to each of the different scenarios and each of the different plans 454 associated with the bid requests. The managers may also include text with the bid requests that are submitted to the issuers. This text may include any type of information in which the manager would like to present to the issuers, including instructional information, advertising, etc. A text field (not shown) may be provided upon selection of the “add manager memo” button 380, for example, in order to allow the manager to provide such information to the issuer.

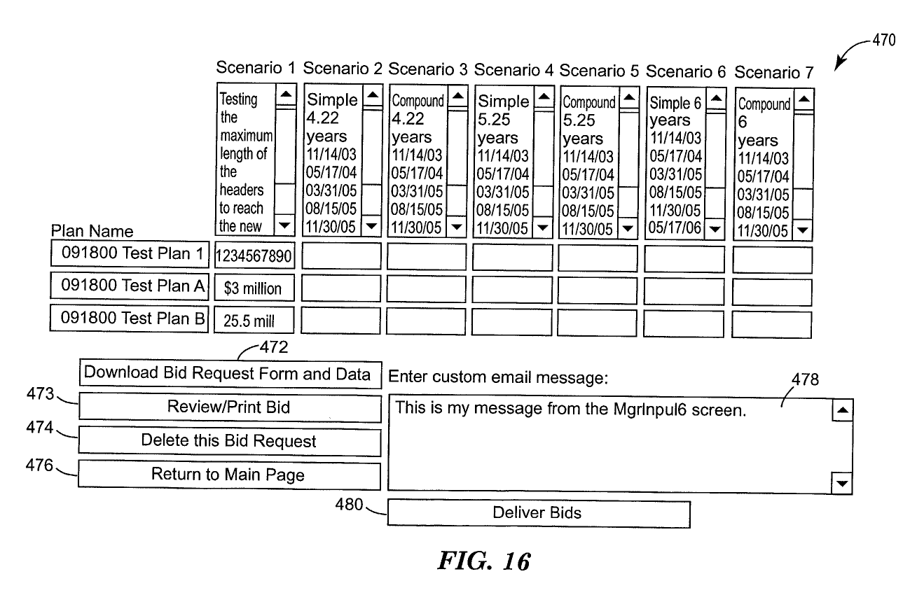

Upon selection of the “preview bid” button 382 shown in FIG. 10, a preview bid form screen 470 is provided to the manager as shown in FIG. 16. This screen allows the managers to preview the bid in the format that the issuers will be presented with. The managers will then be able to choose between a plurality of selectable options, including selecting the “download bid request form and data” button 472, which allows the manager to download the requested form to a local memory or storage device. Other options include reviewing and/or printing the bid by selecting button 472, deleting this bid request by selecting button 474, returning to the main page by selecting button 476, entering a custom e-mail message in text field 478, and delivering the bids by selecting the “deliver bids” button 480. Selection of the “deliver bids” button 480, or the “deliver bids” button 384 shown in FIG. 10, delivers the bid requests to the issuers identified to receive the bid requests.

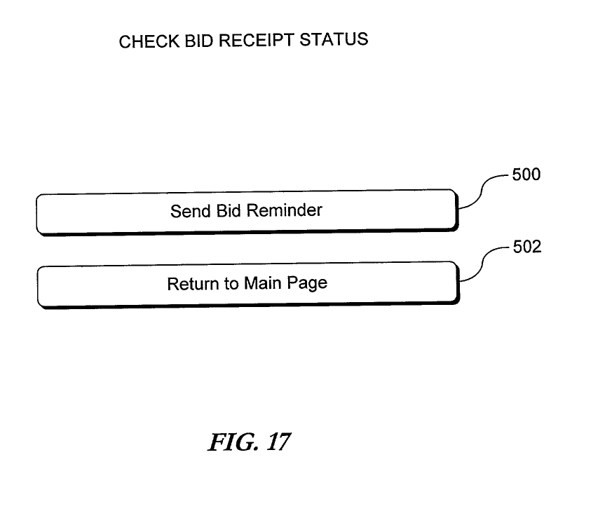

Upon selection of the “check bid receipt status” button 352 shown in FIG. 9, a second tier of user interface buttons or icons may be presented to the manager such as that depicted in FIG. 17. The manager has a plurality of selectable buttons to choose from when checking the bid receipt status, including the “sending a bid reminder” button 500 and the “return to main page” button 502. The selectable buttons provided in FIG. 17 are representative of the types of actions available to managers in connection with checking the bid receipt status. The examples, however, are for illustrative purposes only, as a reduced number or an additional number of options may alternatively be available to the manager.

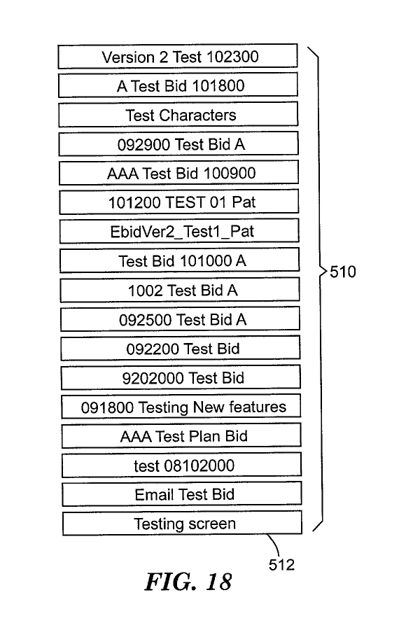

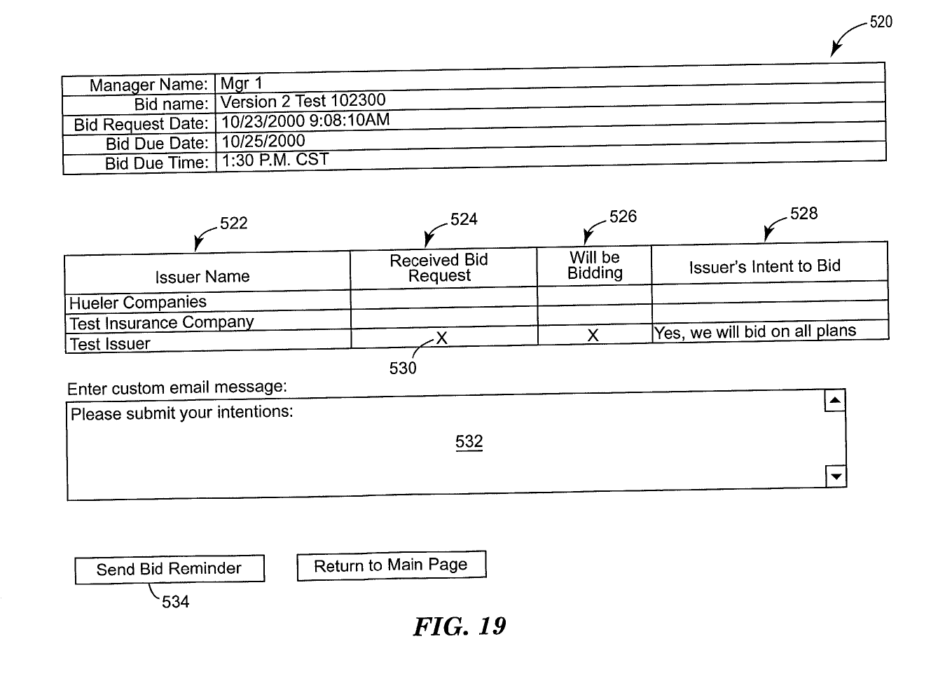

Checking the bid receipt status generally includes providing a report that presents a summary of whether an issuer has confirmed that they received the bid, and whether they intend to respond to the bid request. FIG. 18 illustrates a selectable list 510, from which the manager can select the particular bid name to review confirmations sent by the issuers indicating that the issuers received the bid request and whether the particular issuer intends to respond to the bid request. For example, selection of the bid name 512 will present to the manager an indication of whether or not the issuer has provided confirmation of receipt of the bid request, and whether or not that issuer intends to respond to the bid request. FIG. 19 provides an example of a user interface screen 520 that is presented upon selection of one of the bid names in the selectable list 510 described in connection with FIG. 18. For example, the user interface screen 520 may list each of the issuers selected to receive the bid requests in the issuer name column 522. User interface screen 520 also includes a bid request confirmation column 524, a bid request intention column 526, and an issuer's intent explanation column 528. The bid request confirmation column 524 includes an identifying mark, such as the “X” 530, if the issuer has indeed confirmed receipt of the bid request. The bid request intention column 526 includes an identifying mark if the issuer intends to furnish a bid in response to the manager's bid request. Finally, the issuer can provide textual information in the issuer's intent explanation column 528.

The manager is also allowed to enter a custom e-mail message to a particular one or more of the issuers in the text entry field 532, and upon selection of the “send bid reminder” button 534, the e-mail message provided in field 532 is sent to the targeted issuers. For example, the manager can include text in field 532 to remind the nonresponsive issuers to provide a bid, or at least to confirm receipt of the bid request and provide their intent to bid, which is then sent upon activation of the “send bid reminder” button 534. Similarly, a bid reminder can be initiated upon selection of the “send bid reminder” button 500 previously depicted in FIG. 17. Another purpose for the e-mail text field 532 would be to remind the issuers that the period for responding to the bid is coming to a close, to prompt issuers who have not yet responded to do so.

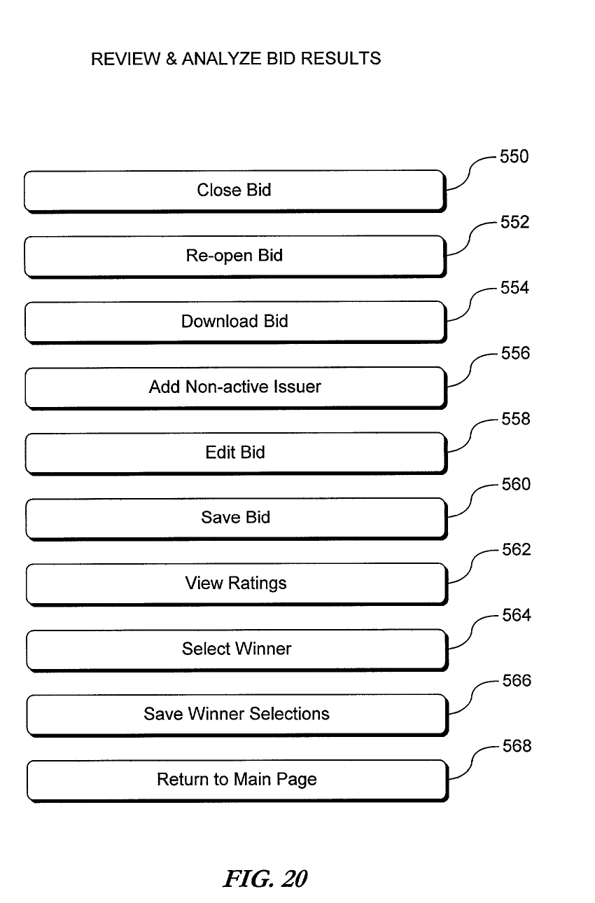

Upon selection of the “review & analyze bid results” button 354 of FIG. 9, a second tier of user interface buttons or icons may be presented to the manager such as that depicted in FIG. 20. The manager has a plurality of selectable buttons to choose from when reviewing and analyzing the issuer's bid results, including closing the bid 550, reopening the bid 552, downloading the bid 554, adding a non-active issuer 556, editing the bid 558, saving the bid 560, viewing ratings 562, selecting a winner 564, saving winner selections 566, and returning to the main page 568. The selectable buttons provided in FIG. 20 are representative of the types of actions available to managers in connection with reviewing and analyzing bid results. The examples, however, are for illustrative purposes only, as a reduced number or an additional number of options may alternatively be available to the manager.

Selection of the “close bid” button 550 is used to prevent any new bids from being submitted by the issuers after selection of the “close bid” button 550. Selection of the “reopen bid” button 552 allows new bids to be submitted even after the bid has been closed. The “download bid” button 554 allows copies of the bid data to be downloaded to a spreadsheet stored locally, such as on a local drive. The “add non-active issuer” button 556 allows a bid to be entered manually. The “edit bid” button 558 allows the manager to enter Treasuries or revise and issuer's bid, and the “save bid” button 560 saves the changes made to the bid. The “view ratings” button 562 allows the manager to view issuer credit ratings, the bid date, bid time, etc. The “select winner” button 564 allows the bids having the most desirable characteristics to be selected as the winning bids. Only issuers active in the system can be selected as a winner and have automated confirmations generated in response, where non-active issuers will not have automated confirmations provided. The “save winner selections” button 566 allows the selected winners to be saved before moving onto the next plan in the event that multiple plans have been provided in this bid.

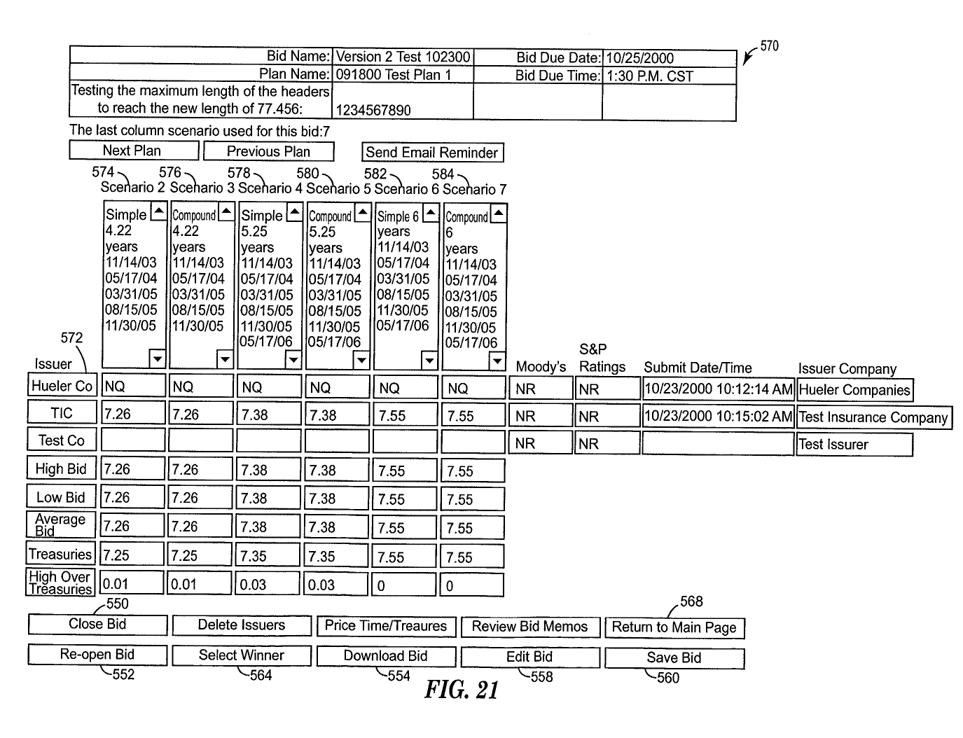

Upon selection of the “review and analyze bid results” button 354 shown in FIG. 9, the user may be presented in with a review bid response screen 570 shown in FIG. 21. Many of the functions shown in FIG. 20 are accessible via the user screen 570 shown in FIG. 21, including a “close bid” button 550, a “reopen bid” button 552, a “download bid” button 554, an “edit bid: button 558, a “save bid” button 560, a “select winner” button 564, and a “return to main page” button 568. The review bid response screen 570 lists each of the responding issuers in column 572, which also includes listings for the highest bid, lowest bid, average bid, and other information. The bids provided for each of the different scenarios 574, 576, 578, 580, 582, 584, etc. by each of the different issuers listed in the issuer identification column 572 allow all of the bid responses to be comparatively viewed.

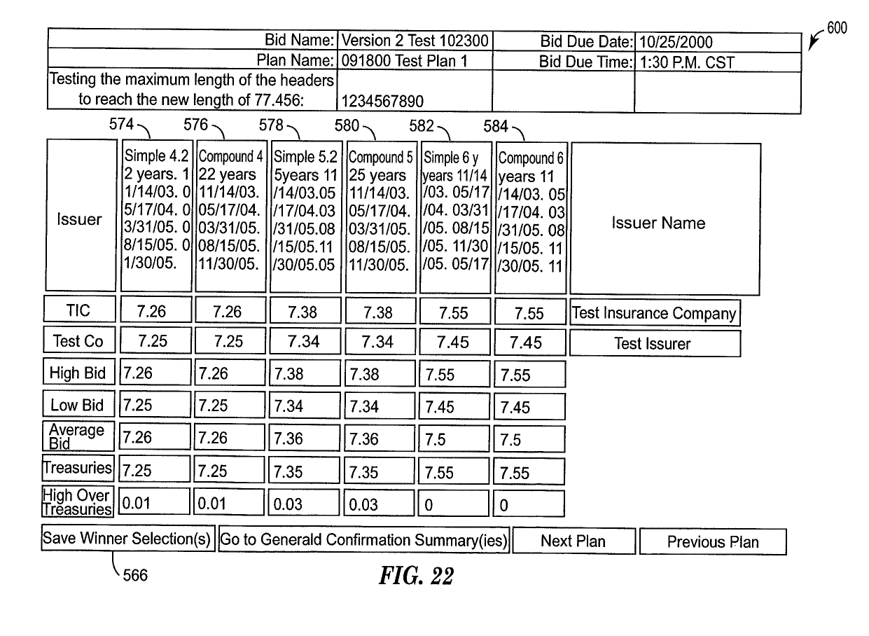

Upon selection of the “select winner” button 564, a select bid winner(s) screen 600 is presented as shown in FIG. 22. From this screen, the winning bid(s) can be highlighted, such as by selecting the particular winning bids for each of the different scenarios identified in columns 574, 576, 578, 580, 582, 584, etc. The winning cells of the matrix can be highlighted for the manager's convenience upon selection by the manager, and the winner for each plan can then be saved by selecting the “save winner selection(s)” button 566, that may also be available from a higher level user interface window shown in FIG. 20.

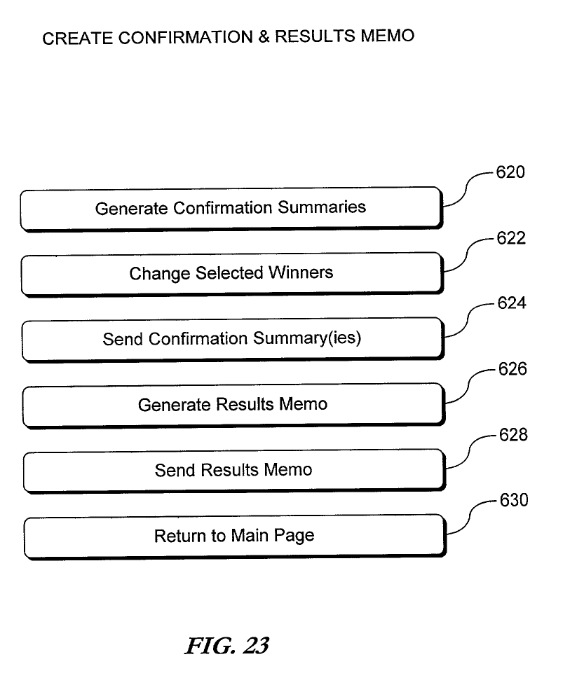

Upon selection of the “create confirmation and results memo” button 356 of FIG. 9, a second tier of user interface buttons or icons may be presented to the manager such as that depicted in FIG. 23. The manager has a plurality of selectable buttons to choose from when creating confirmation and results memorandums, including generating confirmation summaries 620, changing selected winners 622, sending confirmation summary(ies) 624, generating results memos 626, sending results memos 628, and returning to the main page 630. The selectable buttons provided in FIG. 23 are representative of the types of actions available to managers in connection with creating confirmation and results memos. The examples, however, are for illustrative purposes only, as a reduced number or an additional number of options may alternatively be available to the manager.

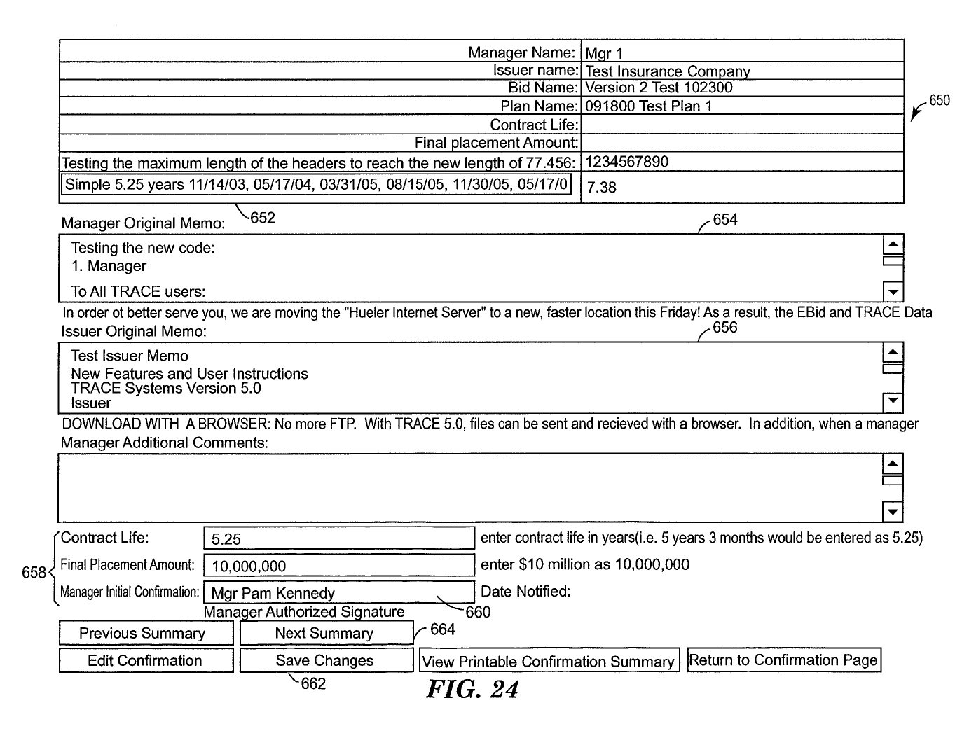

Selection of the generate confirmation summaries button 620 provides a summary of the agreement information along with the original manager and issuer memos. An example of such a confirmation summary is shown in FIG. 24 which provides a confirmation summaries screen 650. The confirmation summaries screen includes information as to the particular agreed-upon bid shown in field 652, for example, and further includes the various manager memos 654 and issuer memos 656. More specific information as to the particular contract is provided in fields 658. The deal can be authorized by the manager by typing the managers name in the signature field 660. If any changes have been made, the manager can select the “save changes” button 662 to permanently save the edited information. The “next summary” button 664 will be provided if the manager has selected more than one winner throughout the entire bid. For example, two different winners for one plan, two different winners for two plans, etc.

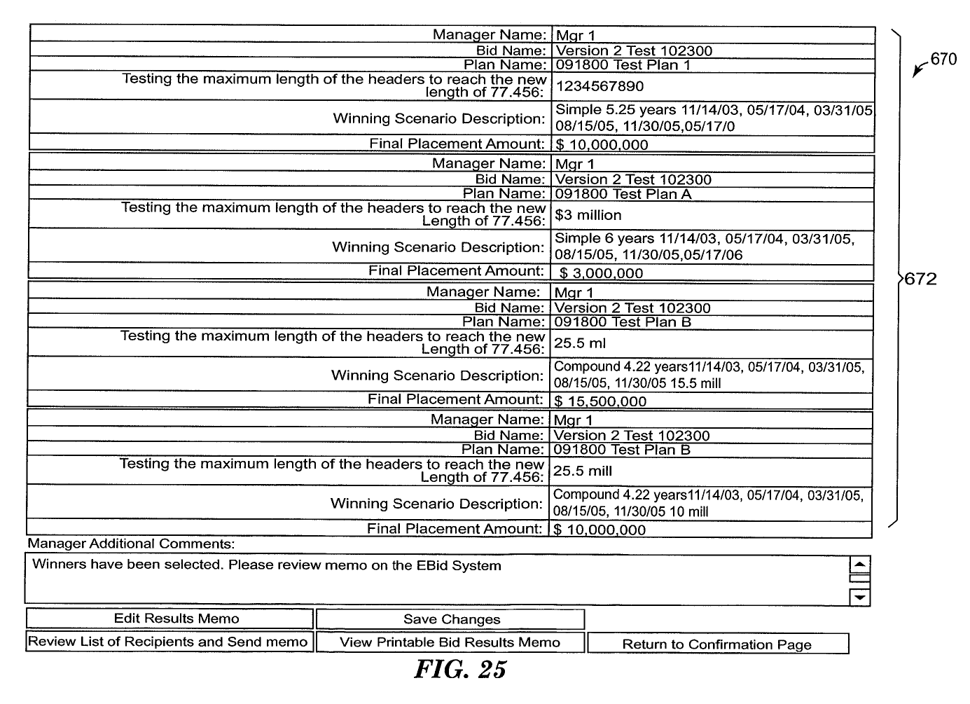

Selection of the “change selected winners” button 622 shown in FIG. 23 allows the selected winners to be changed if the manager subsequently realizes that an error has been made. Selection of the “send confirmation summaries” button 624 allows confirmations to be automatically sent to the selected winners. Selection of the “generate results memos” button 626 provides a brief summary of the winning deals for a specific bid that can be automatically sent to all issuers that submitted a response for the bid, whether or not the issuers won the bid or not. Alternatively, results memos may be sent only to non-winning issuers, while confirmation summaries are sent to the winning issuers. The user interface screen 670 shown in FIG. 25 provides an example of a bid results memo generated by activating the “generate results memo” button 626 of FIG. 23. Each of the winning bids is listed in the results table 672, which is then sent to all designated issuers.

Selection of the “contract confirmation log” button 358 of FIG. 9 creates a confirmation communication status log between managers and issuers for each contract purchased via the electronic bidding system of the present invention.

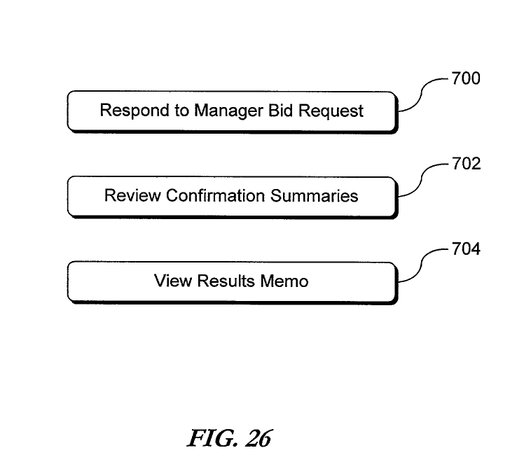

FIG. 26 illustrates a generic user interface providing sellers, such as stable value contract issuers, an interface to the electronic bidding system of the present invention. The example user interface in shown in FIG. 26 includes a graphical user interface (GUI) having a plurality of graphical buttons or icons that can be selected by the issuer. In the example of FIG. 26, the issuer can select a button to respond to the manager bid request 700, review confirmation summaries 702, and view the results memo 704.

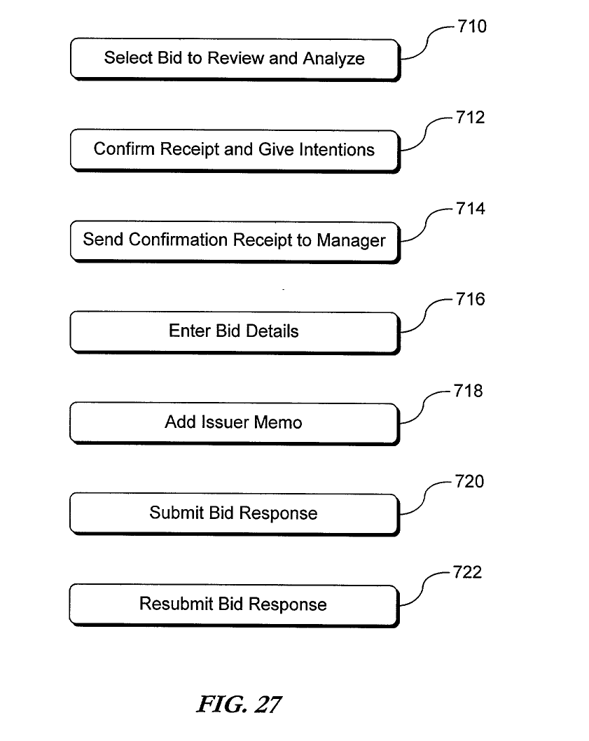

Upon selection of the respond to manager bid request button 700, a second tier of user interface buttons or icons may be presented to the issuer such as that depicted in FIG. 27. The issuer has a plurality of selectable buttons to choose from when responding to a manager bid request, including selecting a bid to review and analyze 710, confirming receipt and providing bid intentions 712, sending confirmation receipt to the requesting manager 714, entering bid details 716, adding issuer memos 718, submitting the bid responses 720, and resubmitting the bid responses. The selectable buttons provided in FIG. 27 are representative of the types of actions available to issuers in connection with responding to manager bid requests. The examples, however, are for illustrative purposes only, as a reduced number or an additional number of options may alternatively be available to the issuer.

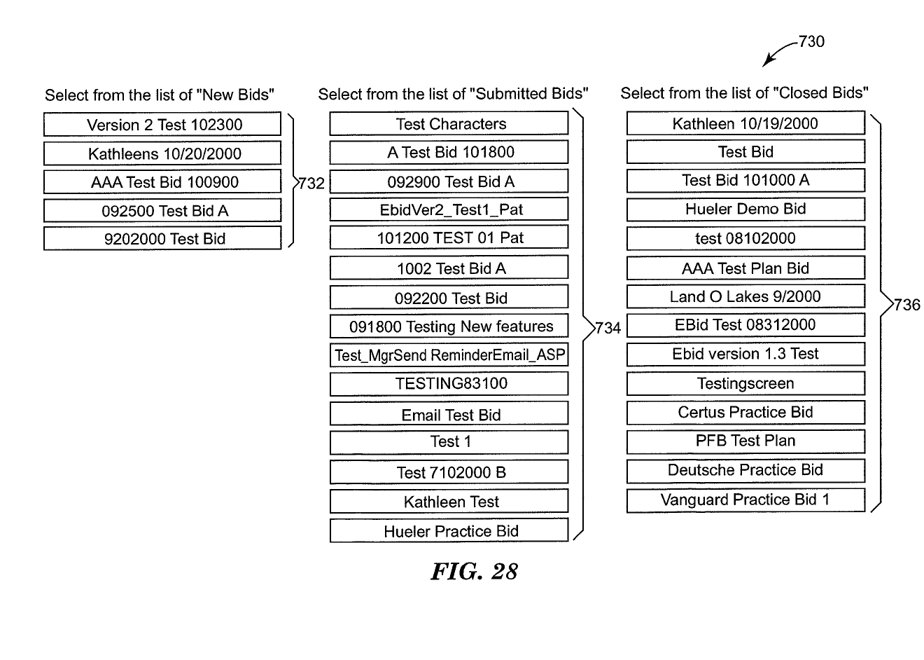

Upon selection of button 710, issuers can select the bid to review from a collection of bids separated by category. For example, bids may be categorized as “new bids” which have not yet been reviewed or responded to, “submitted bids” that have already been responded to, and “closed bids” that have been closed by the managers. Any bid can be reviewed upon it's selection. FIG. 28 provides an example user interface 730 of the categorized bids that can be selected by the issuer for review and/or response. Bid category 732 includes those bids that are “new,” i.e., that have not yet been reviewed or responded to. Bid category 734 includes those bids that have already been responded to, i.e., have already been submitted to the managers. Bid category 736 includes those bids that have been closed by the managers, therefore allowing review, but not further response, by the issuers.

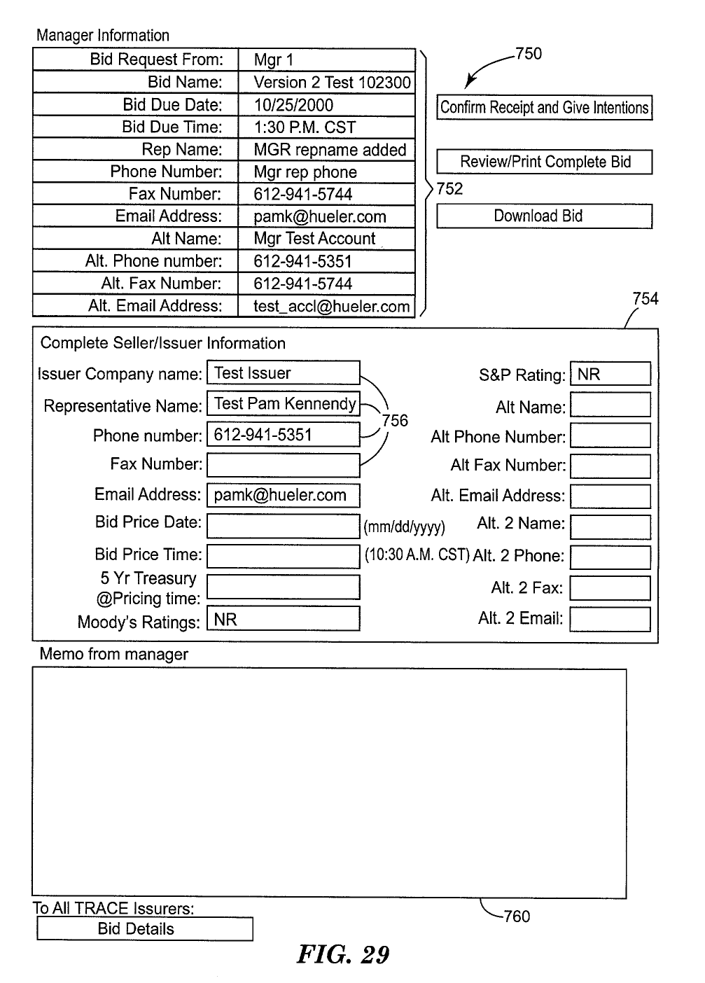

FIG. 29 is an example user interface screen 750 for use by issuers in responding to manager bid requests. Included on this user interface 750 is a table 752 of manager information, seller/issuer information entry field area 754 which includes a plurality of text entry fields, e.g., fields 756, in which the issuer can provide information relating to the issuer, issuer contact information, and other information. A memo field 760 allows the issuer to review information provided by the manager.

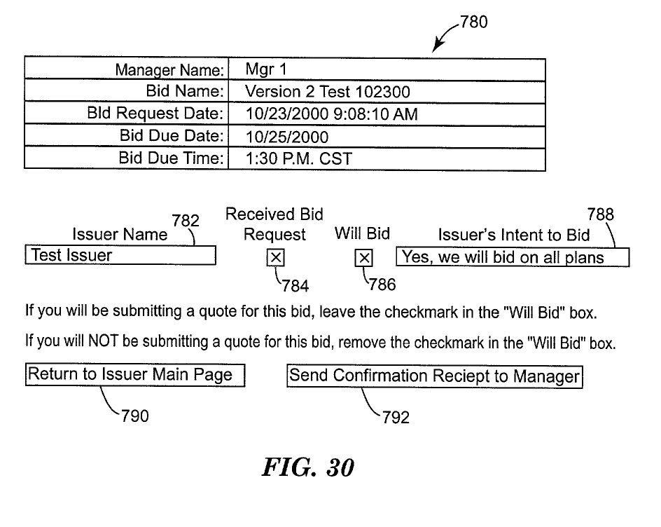

Selection of the “confirm receipt and give intentions” button 712 of FIG. 27 presents a user interface screen such as screen 780 shown in FIG. 30. Through this user interface, the issuer can identify itself in the issuer name field 782, can confirm that it has received the bid request via check box 784, can indicate whether or not the issuer intends to respond to the bid request with a bid via check box 786, and can provide further information regarding the issuer's intent to bid in the text field 788. In one embodiment, the check box 786 is checked by default, and the issuer is requested to uncheck box 786 if the issuer does not intend to submit a quote. From this screen, the issuer may choose to return to the issuer main page upon selection of user interface button 790, or may choose to send the confirmation receipt back to the manager by selecting user interface button 792. The issuer may also send the confirmation receipt to the manager by selecting user interface button 714 shown in connection with the user interface of FIG. 27.

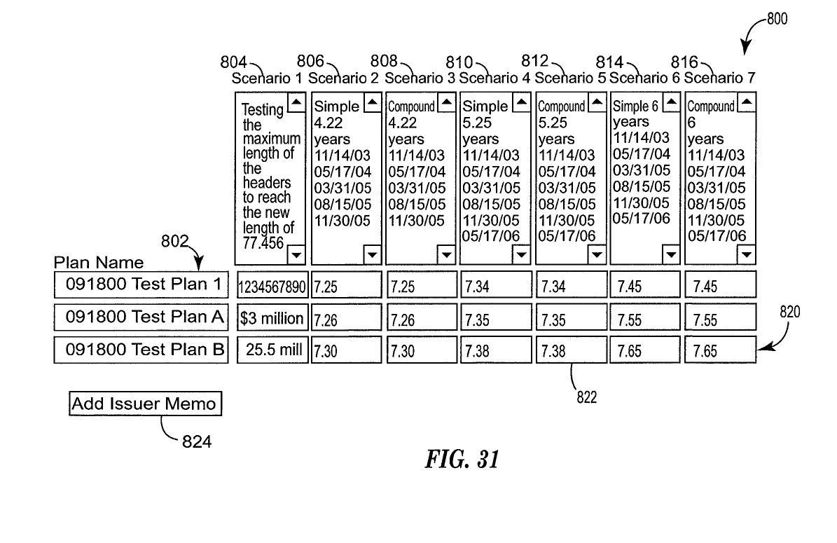

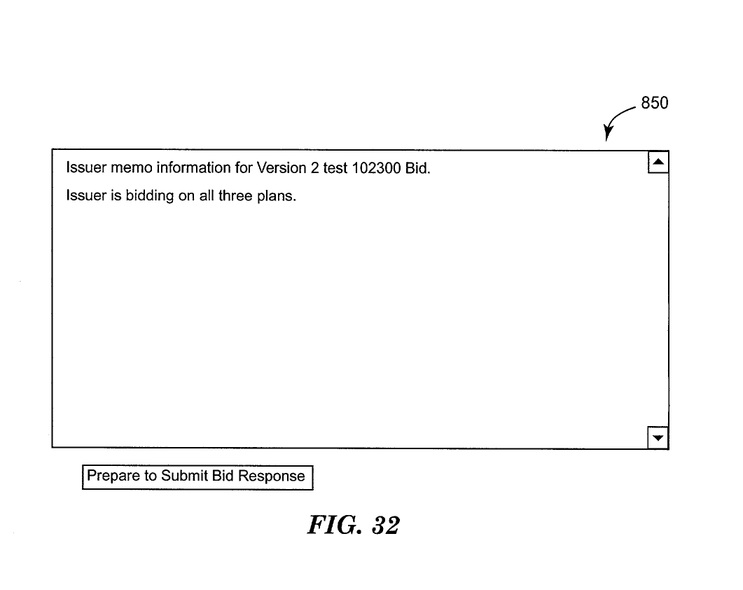

Upon selection of the “enter bid details” button 716 of FIG. 27, the issuer is presented with an issuer bid response entry interface 800 as shown in FIG. 31. This view will appear similar to what the manager previewed via user interface screen 470 previously shown in connection with FIG. 16. In this view, each of the various scenarios in which bid requests are made for each of the plans listed in column 802 are provided in columns 804, 806, 808, 810, 812, 814, 816, etc. For each plan and each scenario, the issuer enters a quote, such as a percent return for a stable value fund contract, at each row/column intersection point (e.g., cell or matrix point). For example, for the plan at row 820, in connection with the bid request scenario identified at column 812, the issuer has bid the numerical bid response of 7.38% shown in cell 822. The issuer can also include a memorandum to return to the manager by activating the user interface button 824. Selection of the user interface button 824, and/or selection of the add issuer memo 718 of FIG. 27, produces a text entry field 850 illustrated in FIG. 32. Through this text entry field, issuers can input any type of text desired to provide to the manager.

Selection of the submit bid response button 720 of FIG. 27 then submits the bid response back to the requesting manager. In this manner, the requesting manager can view the issuers responsive bid as it compares to the responsive bids of other issuers. Further, selection of the resubmit bid response button 722 allows the issuer to provide updated rates on a bid(s) that has already been sent.

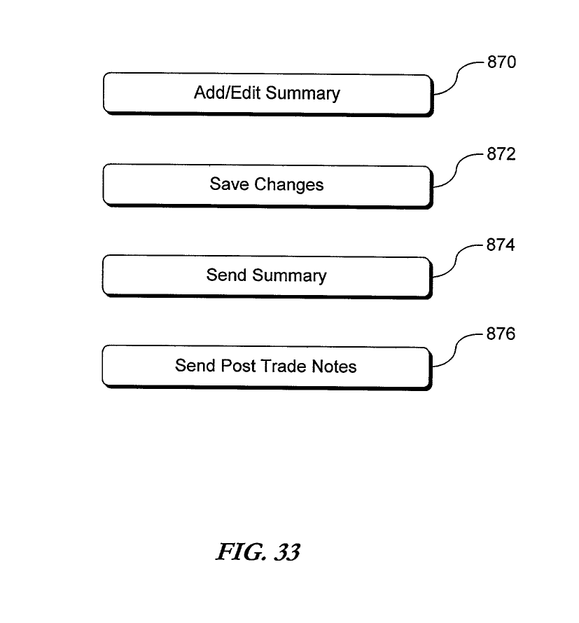

Upon selection of the review confirmation summaries button 702, a second tier of user interface buttons or icons may be presented to the issuer such as that depicted in FIG. 33. The issuer has a plurality of selectable buttons to choose from when reviewing confirmation summaries, including adding/editing the summary 870, saving changes 872, sending the summary 874 and sending post trade notes 876. The selectable buttons provided in FIG. 33 are representative of the types of actions available to issuers in connection with reviewing confirmation summaries. The examples, however, are for illustrative purposes only, as a reduced number or an additional number of options may alternatively be available to the issuer.

Upon selection of button 702 of FIG. 26, the issuer can review all confirmations for any plan in which the manager selected that issuer as the winner. The issuer can select the review confirmation summaries button 702 to review this information, and can enter additional issuer comments and acceptance by selecting the “add/edit summary” button 870 of FIG. 33. In one embodiment of the invention, the issuer can select the “review confirmation summaries” button 702 to monitor for winning bids. Alternatively, an e-mail notification can be sent to the winning issuer to inform the issuer that the issuer has received a winning confirmation summary from the particular manager, along with the bid name, the plan name, and a hyperlink to the Internet site from which the issuer can review the results and finalize the transaction.

When the issuer has been notified of a winning bid, the issuer may add to or edit the confirmation summary through selection of the “add/edit summary” button 870. Selecting the “save changes” button 872 saves any additions or edits made to the confirmation summary. The issuer can then send the confirmation summary back to the manager with any additions or modifications upon selection of the “send summary” button 874.

After the initial confirmation communication is complete, managers and issuers are provided the opportunity to communicate facts about the contract while the contract is in force. Managers can notify issuers of asset swaps, changes to the investment guidelines or other contract specific details. Issuers can acknowledge receipt of that information, and give their response. Issuers initiate these post trade notes by selecting button 876.

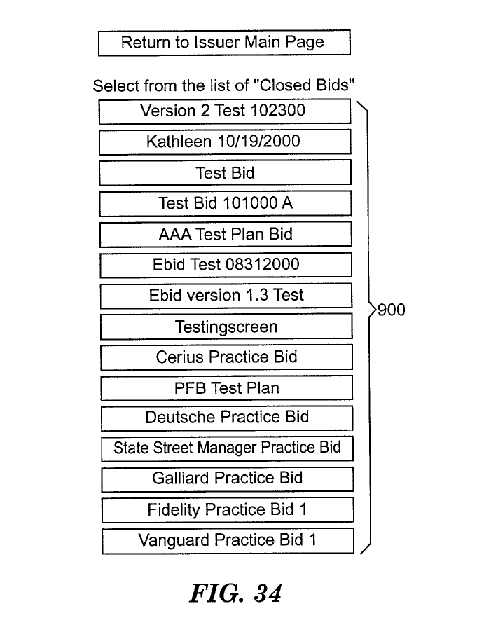

Selection of the “view results memo” button 704 presents the issuer with a list of closed bids, such as the closed bid list 900 shown in FIG. 34. The issuer can select a closed bid from the list 900 to review the results for bids that have been submitted and for which managers have selected a winner. In this manner, each of the issuers who did not win the bid can see what the winning bids were for all bids submitted by that issuer.

It will, of course, be understood that various modifications and additions can be made to the various embodiments discussed hereinabove without departing from the scope or spirit of the present invention. Accordingly, the scope of the present invention should not be limited by the particular embodiments discussed above, but should be defined only by the claims set forth below and equivalents thereof.

What is claimed is:

1. A method for facilitating investment contract bidding between investment contract buyers and investment contract sellers; comprising:
creating, by at least one buyer, an electronic bid invitation;
designating one or more of the sellers in which a bid is desired;
electronically dispatching the electronic bid invitation to the designated sellers to prompt the sellers to furnish the bid;
submitting electronic bid responses, by the designated sellers, to the buyer in response to the electronic bid invitations;
identifying, by the buyer, a most favorable one or more of the electronic bid responses; and
electronically notifying the seller who submitted the most favorable bid response that the buyer is requesting to enter into an investment contract with the winning seller at terms substantially defined by at least the bid response.

2. The method of claim 1, wherein the most favorable electronic bid response is determined by identifying the highest quoted rate of return for a stable value fund.

3. The method of claim 1, wherein the buyer is a stable value fund manager and the sellers are issuers of stable value fund contracts.

4. The method of claim 1, wherein creating an electronic bid invitation comprises creating at least one desired investment scenario to which the designated sellers can provide a quoted rate of return for the desired investment scenario.

5. The method of claim 1, further comprising electronically providing result information to each of the sellers who submitted a bid response.

6. The method of claim 1, wherein the most favorable electronic bid response corresponds to the bid response in which the buyer is most willing to enter into the investment contract based upon information submitted in the electronic bid response.

7. The method of claim 1, further comprising a computer-readable medium having computer-executable instructions for performing the steps recited in claim 1.

8. A method for facilitating investment contract bidding between stable value managers and issuers of stable value investments, wherein both the managers and issuers are coupled for communication via a network, the method comprising:
providing a manager user interface to accept manager entry of bid parameters for at least one investment contract, and to accept manager entry of a designation of one or more issuers in which investment contract bids are solicited;
transmitting, via the network, bid invitations including the bid parameters to each of the designated issuers in which the investment contract bids are solicited;
providing an issuer user interface to accept entry of bid response information by the designated issuers for the at least one investment contract;
transmitting bid responses, including the bid response information, to the manager via the network; and
providing a manager selection user interface to the manager to facilitate comparative analysis of the bid response information received from the one or more issuers, and to allow selection of a desired one or more of the bid responses as a winning bid.

9. The method of claim 8, further comprising transmitting a winning result notification, via the network, to the issuer that submitted the winning bid.

10. The method of claim 8, further comprising transmitting a results notification, via the network, to each of the issuers that submitted a bid response.

11. The method of claim 8, further comprising transmitting verification messages between the manager and the issuer that submitted the winning bid, in order to establish a contract corresponding to the bid parameters and the bid response information between the manager and the winning issuer.

12. The method of claim 8, further comprising transmitting alteration messages between the manager and the issuer that submitted the winning bid, in order to modify and establish a contract corresponding to the bid parameters and the bid response information between the manager and the winning issuer.

13. The method of claim 8, wherein the network comprises the Internet, and the manager user interface, issuer user interface, and manager selection user interface are hosted via an Internet web site.

14. A transaction processing system for facilitating investment contract bidding between investment managers and investment contract issuers; comprising:
(a) a manager computing device comprising:
(1) bid parameter entry means for facilitating manager creation of bid solicitations that include bid parameters for at least one investment contract;
(2) issuer designation means for facilitating manager designation of one or more contract issuers to receive the bid solicitations;
(3) means for transmitting the bid solicitations to each of the designated contract issuers;
(4) bid selection means for allowing the manager to comparatively analyze one or more bid responses provided by the designated contract issuers in response to receipt of the bid solicitations, and for facilitating manager selection of at least one of the bid responses as a winning bid response;
(b) at least one issuer computing device comprising:
(1) receipt means for receiving the bid solicitations;
(2) bid response entry means for facilitating issuer entry of bid response information in response to the bid solicitation to create the bid responses;
(3) means for transmitting the bid responses back to the manager; and
(c) a network coupled to the manager computing device and the at least one issuer computing device to facilitate transmission of the bid solicitations and the bid responses therebetween.

15. The transaction processing system as in claim 14, wherein the manager computing device further comprises means for providing a bid win notification to the issuer who submitted the winning bid response.

16. The transaction processing system as in claim 14, wherein the network comprises the Internet.
